(19) United States
(12) Patent Application Publication
(10) Pub. No.: US 2008/0307248 A1
(43) Pub. Date: Dec. 11, 2008

(54) Cpu Clock Control Device, Cpu Clock Control Method, Cpu Clock Control Program, Recording Medium, and Transmission Medium

(76) Inventors: Katsushige Amano, Kyoto (JP); Masashige Mizuyama, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/583,657

(22) PCT Filed: Apr. 20, 2005
(86) PCT No.: PCT/JP2005/007540

§ 371 Date: Jun. 21, 2006

(30) Foreign Application Priority Data
Apr. 28, 2004 (JP) 2004-133102

(51) Int. Cl. G06F 1/08; G06F 9/46; G06F 13/24

(52) U.S. Cl. 713/600; 718/102; 718/107; 710/267

(57) ABSTRACT

A program execution time determining portion determines an execution start time and a processing volume per unit time of a program in such a manner that a processing volume necessary to execute the program is made equal to the extent that registered request for the execution time and allowable range are met. It is thus possible to determine the execution time of the program in such a manner that a necessary processing volume is made as equal as possible within the allowable range of the request for the execution time of the program, which enables clock control that suppresses a variation of the operating frequency of the CPU. Power consumption of the CPU can be thus reduced.

### TECHNICAL FIELD

The present invention relates to a CPU clock control device that reduces power consumption by controlling an operating frequency of the CPU in an information processing apparatus, a CPU clock control method, a CPU clock control program, a recording medium, and a transmission medium.

### BACKGROUND ART

An information processing apparatus (computer) operates as its central processing unit (CPU) interprets and executes an instruction, and power consumed by the CPU varies with an operating frequency (the number of clocks inputted per unit time). Various methods have been proposed and put into practice to reduce power consumption of the CPU by controlling the operating frequency.

As a typical power reducing method, a method has been known, by which a requested processing is performed as fast as possible by driving the CPU at the maximum operating frequency while suspending the clock in a time (idle time) during which no processing is necessary. For example, assume that the CPU whose maximum operating frequency is 100 MHz needs to perform a processing requiring 50 M (mega) clocks within one second. In this case, the CPU is driven at the operating frequency of 100 MHz for 0.5 second to complete the processing and the clock is suspended completely for the remaining 0.5 second. Alternatively, minimum operating frequency at which the processing can be completed within the requested time is computed and the CPU is driven at the operating frequency thus computed. For example, when the CPU needs to perform a processing requiring 50 M clocks within one second, the CPU is driven at 50 MHz for one second. Both of the two methods save power consumption of the CPU by using only minimum clocks necessary for the processing in reducing useless clocks.

As a technique for computing and using the minimum operating frequency at which the processing is completed within a requested time, it has been disclosed a clock control device that operates the CPU at the minimum necessary operating frequency using performance information of the CPU requested for each task (see Patent Document 1). Also, an arithmetic processing system has been invented, by which the operating frequency is changed to finish a task without delay in a system provided with more than one CPU (see Patent Document 2).

Power that the CPU consumes for an input of one clock is known to be proportional to the square of the power supply voltage. Also, in order to increase the operating frequency of the CPU, it is often necessary to increase the power supply voltage at the same time. Power that such a CPU consumes per clock therefore varies with an operating frequency, and a total of power consumption varies even when a processing volume is the same. For example, when the CPU that needs a power supply voltage proportional to the operating frequency is used, a total number of clocks (=processing volume) for one second is the same for the two power reducing methods in the related art described above; however, the power consumption for one second of the latter is reduced to ¼ of the former. Likewise, when processings of the same volume are performed within the same time, power consumption can be smaller by driving the CPU at a constant operating frequency without changing the operating frequency as much as possible. For example, power consumption becomes smaller by driving the CPU at 150 MHz for one second than by driving the CPU at 200 MHz for the first 0.5 second and at 100 MHz for the remaining 0.5 second. The relation of the power supply voltage and the operating frequency depends on the design of the CPU. As has been described above, however, a significant power reducing advantage can be often achieved by driving the CPU at the same operating frequency without generating an idle period to the extent that the request for a processing volume is met.

When a battery is used to supply power, it is reported that energy within the battery can be used more effectively when power consumption per unit time is stable. Also, a task scheduling algorithm using this report has been disclosed (see Non-Patent Document 1).

However, when a processing is performed on the information processing apparatus, an execution time, such as the start time and the end time or the execution cycle of the processing, is often specified. For example, to give a picture of a video, a processing has to be performed periodically at times each corresponding to one frame of the video. Under some circumstances, plural periodical processings each having a different cycle or a large number of aperiodical processings for which execution times are specified are performed simultaneously. Such time-specified processings can be achieved, for example, by using a timer event managed by the operating system (OS) of the information processing apparatus or by waking up a task using the timer event.

The CPU in the related art described above can achieve a significant power saving advantage by controlling the operating frequency to allow the CPU to operate at the same operating frequency without generating an idle period as much as possible. However, time-specified processings, for example, timer events or tasks woken up by the timer events, generally concentrate at a particular time. Conversely, a particular time may become an idle period during which processings are absent. In other words, a processing volume required for the CPU varies with time, and the operating frequency of the CPU varies markedly in response to a processing volume requested at that time even when the invention of the Patent Document 1 is used. Because the operating frequency varies markedly as has been described, there is a problem that the power reducing advantage achieved by the invention of Patent Document 1 is reduced.

Meanwhile, in the processing for which an execution time is specified, such as a timer event, the strictness of requests varies extensively. For example, even when the execution start time is specified, a delay within a certain range is allowed for the execution start time in some cases. However, the control to suppress a variation of the operating frequency of the CPU by smoothing the processing volume required for the CPU to process through the use of such an allowable range of the execution time request is not concerned in the inventions described in Patent Document 1, Patent Document 2, and Non-Patent Document 1, and it is therefore infeasible.

### Patent Document 1: JP-A-8-76874

### Patent Document 2: JP-A-2002-99433

Non-Patent Document 1: IEICE Trans., D-I Vol. J83-D-I, No. 12, pp. 1249-1259.

### DISCLOSURE OF THE INVENTION

The invention was devised in view of the problems discussed above, and is therefore to reduce power consumption of the CPU by smoothing a processing volume required for the CPU in an information processing apparatus.

The above and other objects can be achieved by a CPU clock control device according to one aspect of the invention, which is a CPU clock control device that controls a clock of its own CPU, including: a program execution time registration portion that registers a request for an execution time of a program to be executed by the CPU and an allowable range of the request for the execution time of the program; a program processing volume detection portion that detects a processing volume necessary to execute the program; a program execution time determining portion that determines an execution start time and a processing volume per unit time of the program in such a manner that the processing volume detected by the program processing volume detection portion is made equal within a specific time range to the extent that the request for the execution time and the allowable range registered in the program execution time registration portion are met; a CPU operating frequency setting portion that determines an operating frequency of the CPU at each time on the basis of the execution start time and the processing volume per unit time of the program determined by the program execution time determining portion, and sets the operating frequency in the CPU; and a program execution portion that makes the CPU operating at the operating frequency set by the CPU operating frequency setting portion execute the program at the execution start time and the processing volume per unit time determined by the program execution time determining portion.

The object, features, aspects, and advantages of the invention will become more apparent by the following detailed descriptions and the accompanying drawings.

### BRIEF DESCRIPTION OF THE DRAWINGS

FIG. 1 is a view schematically showing the configuration of an information processing apparatus that constitutes a CPU clock control device according to a first embodiment of the invention.

FIG. 2 is a flowchart detailing operations during CPU operating frequency control in the first embodiment of the invention.

FIG. 3 is a view used to describe one example of processings in the first embodiment of the invention.

FIG. 4 is a view used to describe another example of processings in the first embodiment of the invention.

FIG. 5 is a view schematically showing the configuration of an information processing apparatus that constitutes a CPU clock control device according to a second embodiment of the invention.

FIG. 6 is a flowchart detailing operations during CPU operating frequency control in the second embodiment of the invention.

FIG. 7 is a view used to describe one example of processings in the second embodiment of the invention.

FIG. 8 is a view schematically showing the configuration of an information processing apparatus that constitutes a CPU clock control device in a third embodiment of the invention.

FIG. 9 is a flowchart detailing operations during CPU operating frequency control in the third embodiment of the invention.

FIG. 10 is a view used to describe one example of processings in the third embodiment of the invention.

FIG. 11 is a view schematically showing the configuration of an information processing apparatus that constitutes a CPU clock control device according to a fourth embodiment of the invention.

FIG. 12 is a flowchart detailing operations during CPU operating frequency control in the fourth embodiment of the invention.

FIG. 13 is a view used to describe one example of processings in the fourth embodiment of the invention.

FIG. 14 is a view used to describe another example of processings in the fourth embodiment of the invention.

### BEST MODE FOR CARRYING OUT THE INVENTION

Embodiments of the invention will now be described with reference to the drawings.

### First Embodiment

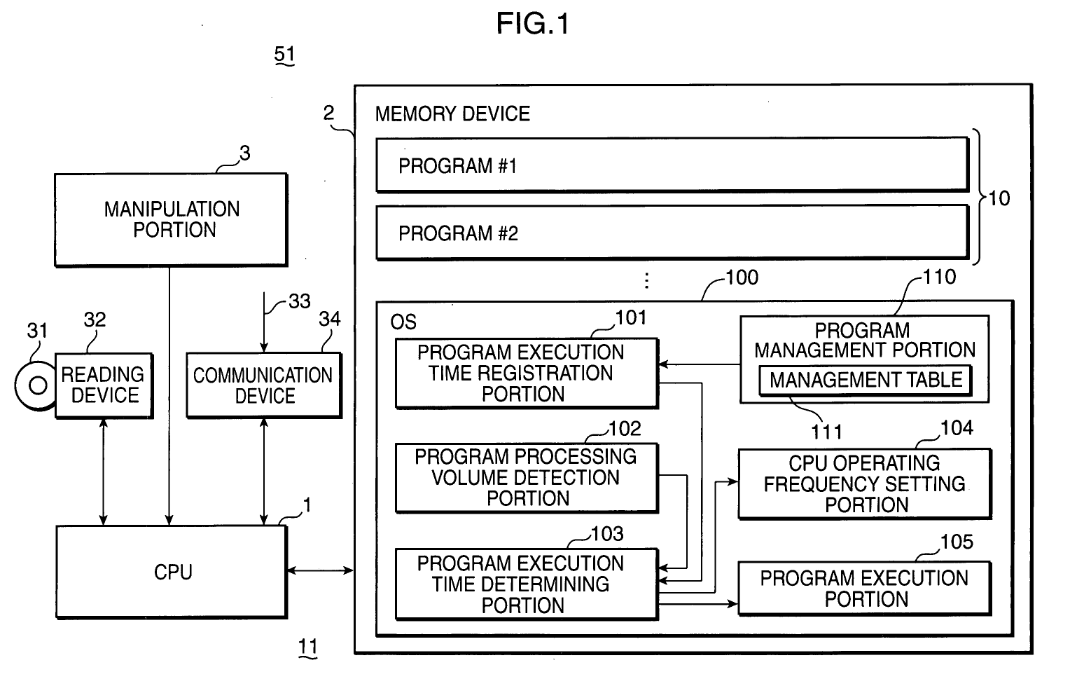

FIG. 1 is a view showing an information processing apparatus that performs CPU operating frequency control according to a first embodiment of the invention. An information processing apparatus 51 includes at least one central processing unit (CPU) 1 and a memory device 2. Also, the information processing apparatus 51 includes a manipulation portion 3 used as an input device. Further, although it is not shown in the drawing, the information processing apparatus 51 may include another device, such as an output device. Regarding the input device and the output device, the same applies to the other embodiments.

The CPU 1 can be of an arbitrary type as long as it is capable of changing an operating frequency. The operating frequency of the CPU 1 is changed by an operating system (OS) 100, more specifically, by a CPU operating frequency setting portion 104 in the OS 100 described below.

At least one program 10 and the OS 100 of the information processing apparatus 51 are installed in the memory device 2. An arbitrary type of memory, such as a random access memory (RAM) and a flash memory, can be used as the memory device 2 as long as it has sufficient capabilities and capacity. Also, the memory device 2 is not necessarily formed of a single memory device, and it may comprise a combination of plural memory devices of the same type or plural memory devices of different types including a read only memory (ROM). Further, an outside storage device, such as a hard disc, may be provided in addition to the memory device 2, so that the contents of the memory device 2 are moved into the outside storage device to the extent that no problem occurs in operations of the information processing apparatus 51.

The program 10 in this embodiment means respective processings performed by the information processing apparatus 51 that are written in the form of a program for the information processing apparatus 51. In other words, individual programs #1, #2, and so forth included in the program 10 can be of arbitrary size and format as long as they are divided into execution units. Also, in this embodiment, the information processing apparatus 51 performs various processings by executing the program 10 under the control of the OS 100.

The program 10 or the like can be supplied via a recording medium 31, such as a ROM, a flexible disc, and a CD-ROM, or it can be supplied via a transmission medium 33, such as a telephone line and a network. Referring to FIG. 1, a CD-ROM is shown as the recording medium 31 and a telephone line is shown as the transmission medium 33. The program 10 or the like recorded in the CD-ROM can be read out, for example, by connecting a CD-ROM reading device 32 serving as an outside device of the information processing apparatus 51 to the main body of the information processing apparatus 51, and stored, for example, in a RAM, an unillustrated hard disc, or the like. In a case where the program 10 or the like is supplied via the recording medium 31 in the form of a ROM, the information processing apparatus 51 becomes able to perform processings according to the program 10 or the like as the ROM is inserted into the information processing apparatus 51. In this case, the ROM is included in the memory device 2. The program 10 or the like supplied via the transmission medium 33 is received through a communication device 34, and stored, for example, in the RAM, an unillustrated hard disc, or the like. The transmission medium 33 is not limited to a cable transmission medium, and it can be a wireless transmission medium.

The OS 100 performs CPU clock control of this embodiment, and therefore includes a program management portion 110, a program execution time registration portion 101, a program processing volume detection portion 102, a program execution time determining portion 103, a CPU operating frequency setting portion 104, and a program execution portion 105. In this embodiment, the program management portion 110, the program execution time registration portion 101, the program processing volume detection portion 102, the program execution time determining portion 103, the CPU operating frequency setting portion 104, the program execution portion 105, and the CPU 1 have the capabilities to operate as a CPU clock control device 11.

The program management portion 110 includes a management table 111. The management table 111 has stored execution start times, allowable ranges, and so forth of respective programs in correlation with individual programs #1, #2, and so forth included in the program 10. The program management portion 110 notifies the program execution time registration portion 101 of the execution start times, allowable ranges, and so forth correlated with the individual programs #1, #2, and so forth designated for execution by the user, for example, via the manipulation portion 3, so that these are registered therein. Herein, the program management portion 110 does not necessarily store the execution start times, allowable ranges, and so forth of the programs, and it is sufficient to have a capability of correlating the individual programs with requests for the execution times of the programs and allowable ranges of the requests for the execution times of the programs.

The program execution time registration portion 101 registers information about the requests for the execution times and the allowable ranges of programs designated for execution by an instruction from the program management portion 110. The program execution time registration portion 101 notifies the program execution time determining portion 103 of the requests for the execution times and the allowable ranges of the programs thus registered.

The request for the execution time of the program means, for example, a request for the start time, that is, a request as to when the execution of the program is started. Alternatively, it may be a request for an end time as to by what time the processing needs to be finished, or an execution cycle in a case where the program is executed periodically, etc. A selection as to which requests to register can be designed according to the purpose of use or the use environment of the information processing apparatus 51.

The allowable range means information indicating to which extent the request for the execution time is allowed to vary. For example, for a request for the start time, a delay or the like allowed for the start time is one example of the allowable range. In a case where it is requested to start an execution one second later, but a delay of 0.1 second is allowed for the start time, one second later is the request for the execution time and the allowable range is +0.1 second. In a case where a periodical execution for each 10 seconds is requested, but a variation, such as a gain or a delay of the cycle for one second, is allowed, the request for the execution time is a 10-second cycle, and the allow able range is ±1 second. As with the request for the execution time, a selection as to which allowable ranges to register and its notation system can be designed according to the purpose of use or the use environment of the information processing apparatus 51.

The request for the execution time and the allowable range, which are the information registered in the program execution time registration portion 101, are delivered as an augment by calling out a function used to register the execution time request when the program is registered or installed in the information processing apparatus 51. The information processing apparatus 51 normally stores a special program for registration or installation. Hence, when the program calls out the function used to register the execution time request described above, a registration processing with the program execution time registration portion 101 can be achieved under the control of the program management portion 110.

The registration mode is not limited to the one described above, and another mode is available, in which the user of the information processing apparatus 51 specifies the request for the execution time and the allowable range when he designates a given program for execution. Further, still another mode is available, in which the request for the execution time and the allowable range are written into the program in the form of codes. The mode in which the request for the execution time of the program and the allowable range are registered as has been described is also applicable when the requests for the execution times and the allowable ranges of tasks or timer events are registered in the embodiments below.

The program processing volume detection portion 102 detects processing volumes necessary when executing the individual programs #1, #2, and so forth included in the program 10, and notifies the program execution time determining portion 103 of the processing volumes. The processing volumes can be detected, for example, by writing necessary processing volumes in the respective programs #1, #2, and so forth and delivering the processing volumes in the form of augments of functions from the respective programs #1, #2, and so forth before the executions. Alternatively, the processing volumes may be written in the headers or the like of the respective programs #1, #2, and so forth, so that the program processing volume detection portion 102 reads out the written values.

For a program executed more than once, a time needed for the program to end may be recorded by actually executing the program, so that a necessary processing volume is measured actually by integrating the operating frequency of the CPU over the recorded time (this is equivalent to multiply the CPU operating frequency when it is constant). Moreover, a method for actually measuring the processing volumes more than once to find an average of data is also available. An arbitrary method can be used as the detection method of processing volumes as long as an actual detection is possible. Also, in this invention, the processing volume necessary for the program is not necessarily an exact value. An advantage can be achieved by roughly classifying the processing volumes to large, medium, and small. This is not limited to this embodiment, and the same applies to the other embodiments below.

The program execution time determining portion 103 determines execution times of the individual programs #1, #2, and so forth included in the program 10 on the basis of the requests for the execution times of the program 10 and the allowable ranges notified from the program execution time registration portion 101, and necessary processing volumes notified from the program processing volume detection portion 102. Herein, the program execution time determining portion 103 determines the execution times of the individual programs #1, #2, and so forth included in each program 10 to the extent that the requests for the execution times and the allowable ranges are met. At the same time, it determines the execution times in such a manner that a sum of the necessary processing volumes of the programs to be executed becomes as constant as possible for each pre-set unit time. In other words, it determines the execution times of the programs so that the necessary processing volumes of the programs per unit time become as equal as possible (equalization). The necessary processing volume for each time is thus smoothed. The program execution time determining portion 103 then notifies the CPU operating frequency setting portion 104 of the processing volumes thus smoothed.

The CPU operating frequency setting portion 104 determines the operating frequency of the CPU on the basis of the processing volumes smoothed by the program execution time determining portion 103. The CPU operating frequency setting portion 104 sets this operating frequency in the CPU 1 by controlling a voltage applied to the CPU 1. Also, for example, the operating frequency may be set as the CPU operating frequency setting portion 104 re-writes the value of the register provided in the CPU 1 that determines the operating frequency.

The frequency to be set is, for example, the minimum operating frequency at which necessary processings are completed exactly within the respective unit times without generating an idle time. Given one second as the unit time, and in a case where a processing requiring 100 M clocks needs to be performed within a given unit time (herein, one second), then the operating frequency is set to 100 MHz for this one second. Alternatively, in order to make an allowance for actual processing volumes, the operating frequency may be set to a frequency that is the minimum necessary operating frequency plus a certain quantity.

In any case, the processing volume to be performed per unit time is smoothed by the program execution time determining portion 103. A variation of the operating frequency set by the CPU operating frequency setting portion 104 is thus lessened in comparison with a case where the smoothing operation is not performed. As has been described, even when the processing volumes are the same, power consumption is smaller when a variation of the operating frequency of the CPU is lessened. Power consumed by the CPU is therefore smaller in comparison with the case where the smoothing operation is not performed.

The program execution portion 105 executes the individual programs #1, #2, and so forth included in the program 10 at the execution times determined by the program execution time determining portion 103 using the CPU 1 that operates at the operating frequency set by the CPU operating frequency setting portion 104.

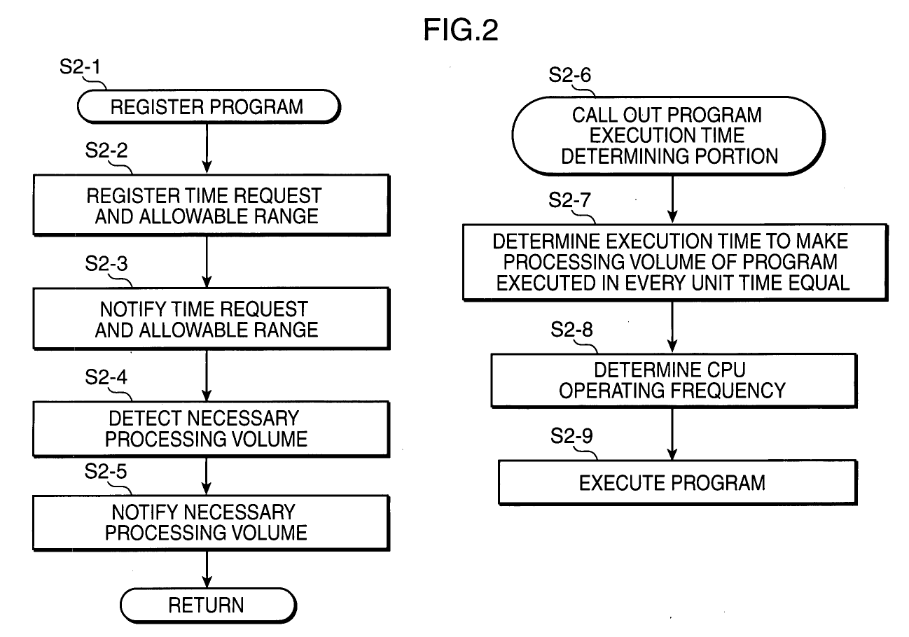

FIG. 2 is a flowchart detailing operations of the CPU clock control device of this embodiment. Step S2-1 through Step S2-5 are operations of the program management portion 110, the program execution time registration portion 101, and the program processing volume detection portion 102. Step S2-6 through Step S2-9 are operations of the program execution time determining portion 103, the CPU operating frequency setting portion 104, and the program execution portion 105.

In Step S2-1, the program management portion 110 loads the programs to be executed by the information processing apparatus 51 into the memory device 2 to be registered therein, for example, from the ROM or the like described above, for example, by manipulations of the user on the manipulation portion 3. Subsequently, in Step S2-2, the program management portion 110 registers the requests for the execution times and the allowable ranges of the registered program 10 into the program execution time registration portion 101 with reference to the management table 111. In Step S2-3, the program execution time registration portion 101 notifies the program execution time determining portion 103 of the requests for the execution times and the allowable ranges thus registered.

In Step S2-4, the program processing volume detection portion 102 detects processing volumes necessary for the programs requested to be executed. As has been described, in Step S2-4, the necessary processing volumes are detected, for example, by calling out functions used to register the execution time requests with the use of the special program for registration and installation pre-installed in the information processing device 51, or by waiting for the programs to be executed actually to actually measure the necessary processing volumes. In Step S2-5, the program processing volume detection portion 102 notifies the program execution time determining portion 103 of the necessary processing volumes of the programs thus detected. In the flowchart of FIG. 2, the registration and notification of the requests for the time and the allowable ranges (S2-2 and S2-3) are performed before the detection and notification of the necessary processing volumes (S2-4 and S2-5). However, these steps are not necessarily performed in this order. Because these steps are independent, they can be performed in arbitrary order.

Step S2-6 is a step of calling out the program execution time determining portion 103. The program execution time determining portion 103 can be called out immediately after a new program is registered, that is, after the program execution time determining portion 103 is notified of the requests for the execution times and the allowable ranges from the program execution time registration portion 101 and of the necessary processing volumes from the program processing volume detection portion 102 (immediately after Step S2-5). Alternatively, it may be called out periodically in a particular cycle or at the completion of a processing for one program.

In S2-7, execution times are determined for all the programs that are requested to be executed and whose requests for the execution times or the like have been notified to the program execution time determining portion 103. As has been described, the program execution time determining portion 103 determines execution times in such a manner that a sum of the necessary processing volumes of the respective programs notified in Step S2-5 per unit time becomes as equal as possible to the extent that the execution time requests and the allowable ranges of the respective programs notified in Step S2-3 are met.

To determine the execution times in Step S2-7 is a general problem to allocate execution times of the programs within the limitations, and various algorithms are available. For example, when the program 10 that needs to be executed has a relatively small number of programs, variations of the processing volumes may be compared with one another by listing all the possible patterns of execution times. It should be noted, however, that perfect equalization is not necessarily achieved in the invention. Because power consumption can be reduced correspondingly by lessening a variation of the CPU operating frequency, even when equalization is not perfect, the power consumption reducing advantage can be achieved correspondingly to the equalization. Hence, the advantage can be achieved, for example, by merely moving the execution of one program to another time from a time at which the necessary processing volume becomes the largest.

Because equalization to some extent is possible even when the necessary processing volumes of programs are approximate values instead of exact values, the power consumption reducing advantage can be achieved in this case, too. Further, the execution times are not necessarily determined for all the programs, and it is sufficient to determine execution times from the current time to a certain time later. Because a computation time is necessary for equalization, to which extent the equalization needs to be precise can be designed according to the purpose of use and the use environment of the information processing apparatus 51.

In Step S2-8, upon receipt of the execution times determined by the program execution time determining portion 103, the CPU operating frequency setting portion 104 determines the operating frequency of the CPU 1, and sets this operating frequency in the CPU 1. In S2-9, the program execution portion 105 executes the programs requested to be executed. The programs are executed at the times determined by the program execution time determining portion 103. Hence, in practice, Step S2-9 is not performed immediately after Step S2-8 is completed, and it is performed when the determined execution time has come.

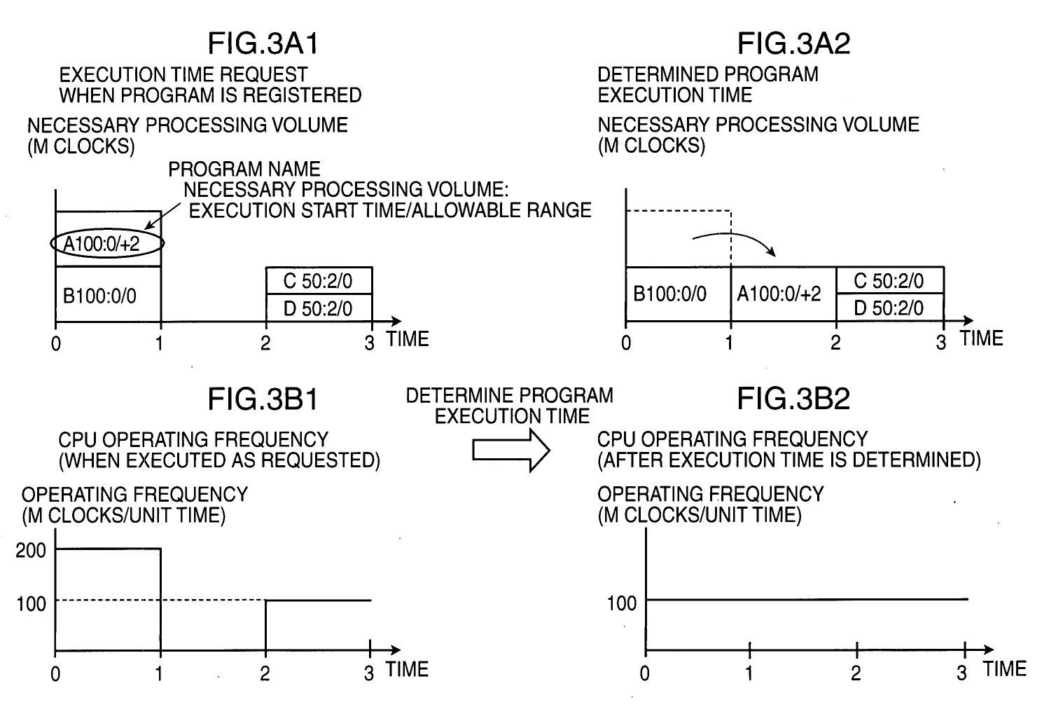

FIG. 3 shows one example of processings performed by the CPU clock control device of this embodiment. FIG. 3A1 is a view schematically showing programs requested to be executed and the execution times requested by these programs, both of which are directly placed on the time axis. FIG. 3A1 shows information notified to the program execution time determining portion 103 as the result of Step S2-1 through Step S2-5 of FIG. 2 by using the abscissa for a time (unit: arbitrary) and the ordinate for a processing volume (M clocks) necessary at that time. A square block represents a program, and the longitudinal size of the block corresponds to a necessary processing volume of each program. In FIG. 3A1, four programs A through D are registered. The value added at the end of a capital letter indicating the program name indicates the necessary processing volume of the program (unit: M clocks), and values added at the end of the necessary processing volume indicate the requested execution start time and the allowable range. In the case of the program A, the necessary processing volume is 100, the execution start time is 0, and the allowable range is +2.

In the examples of FIG. 3, assume that the request for the execution time requests the program to be executed and the processing to be completed from the time indicated by the value to the following time. More specifically, in the case of A, because the execution start time is 0, it requests the program A to be executed and the processing to be completed from the time 0 to the time 1. Hereinafter, this state will be described as “an execution at the time 0 is requested”. In the case of C, because it requests the program C to be executed and the processing to be completed from the time 2 to the time 3, this state is described as “an execution at the time 2 is requested”.

The value of the allowable range indicates a range of a variation of the execution time, and +1 means that a delay up to the time 1 is allowed, and +2 means that a delay up to the time 2 is allowed. In the case of the program A, because the allowable range is +2, although an execution at the request time 0 is requested, an execution at the time 1 or 2 is allowed. In the case of the program B, an execution at the time 0 is requested and the allowable range is 0. Hence, an execution at any other time is not allowed. In the case of the programs C and D, because an execution at the time 2 is requested and the allowable range is 0, these programs have to be executed at this time.

FIG. 3B1 shows a case where the CPU operating frequency is set in such a manner that the programs A through D are executed at the execution times in FIG. 3A1 while completing the respective processings at the minimum necessary operating frequencies at the respective times, that is, without generating any idle period. In FIG. 3B1, the abscissa is used for the time as in FIG. 3A1, but the ordinate is used for the operating frequency (M clocks/unit time) of the CPU 1.

FIG. 3A2 shows actual execution times of the programs determined by the program execution time determining portion 103 after Steps S2-6 and S2-7 are performed. As the result of Step S2-7, the program execution time determining portion 103 determines to execute the program A at the time 1 so that the necessary frequency for each time becomes equal. Herein, executions of the programs from the current time to three times later alone are made equal by taking into account a processing volume necessary for the computation. In short, the range of the times in FIG. 3 alone is concerned.

FIG. 3B2 shows the CPU operating frequency determined by the CPU operating frequency setting portion 104 to achieve the program execution times in FIG. 3A2 determined by the program execution time determining portion 103. In comparison with FIG. 3B1, a variation of the operating frequency is lessened in FIG. 3B2, and power consumption of the CPU during this period can be therefore reduced. In addition, the respective programs are executed within the respective allowable ranges.

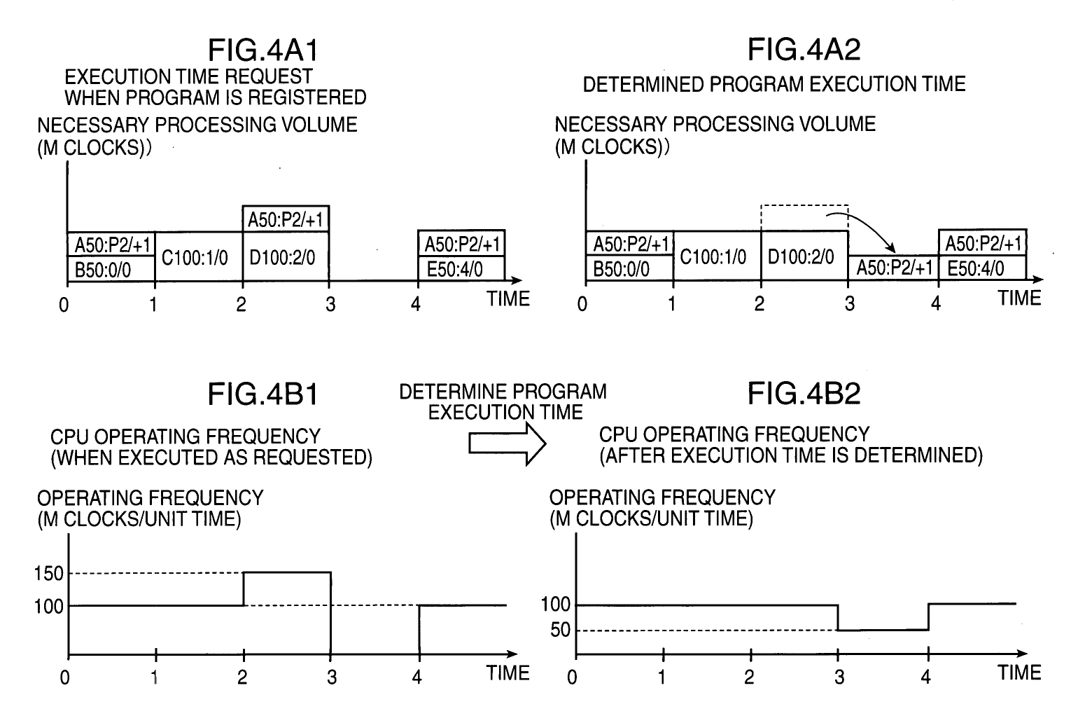

FIG. 4 shows another example of processings performed by the CPU clock control device of this embodiment. As with FIG. 3A1, FIG. 4A1 is a view schematically showing the programs requested to be executed and execution times requested by these programs, both of which are placed directly on the time axis. The program A requests a periodical execution in a cycle 2, and this state is denoted by P2 in the execution time request in FIG. 4A1. Being a periodical execution, the program A requests executions at the times, 0, 2, and 4. However, because the allowable range of the program A is +1, a delay of one time is allowed. FIG. 4A2 is a view schematically showing a state after the execution times are determined by the program execution time determining portion 103. In the case of the example shown in FIG. 4A2, the program A requesting an execution at the time 2 is actually executed at the time 3 with a delay of one time because its allowable range is +1.

FIGS. 4B1 and 4B2 show the operating frequency of the CPU 1 determined by the CPU operating frequency setting portion 104 in a case where the minimum operating frequency necessary to execute programs is used. The operating frequency is not made equal perfectly in FIG. 4B2, either. However, in comparison with FIG. 4B1, a variation of the operating frequency is lessened, and power consumption of the CPU can be reduced correspondingly. In addition, the respective programs A through E are executed within the respective allowable ranges.

As has been described, it is possible in the invention to reduce power consumption of the CPU while the requests for the execution times of the programs are met within the allowable ranges The program 10 in this embodiment does not necessarily include all the processings performed by the information processing apparatus 51, and it may include a particular part. Likewise, the time requests and the allowable ranges are not necessarily registered for all the programs 10. Even when the processing volumes are smoothed for a part of all the processings, the power consumption reducing advantage can be achieved correspondingly to the smoothed part.

In this embodiment of the invention, the program execution time registration portion 101, the program processing volume detection portion 102, the program execution time determining portion 103, the CPU operating frequency setting portion 104, and the program execution portion 105 are provided in the OS 100. However, they can be provided on the outside of the OS 100.

### Second Embodiment

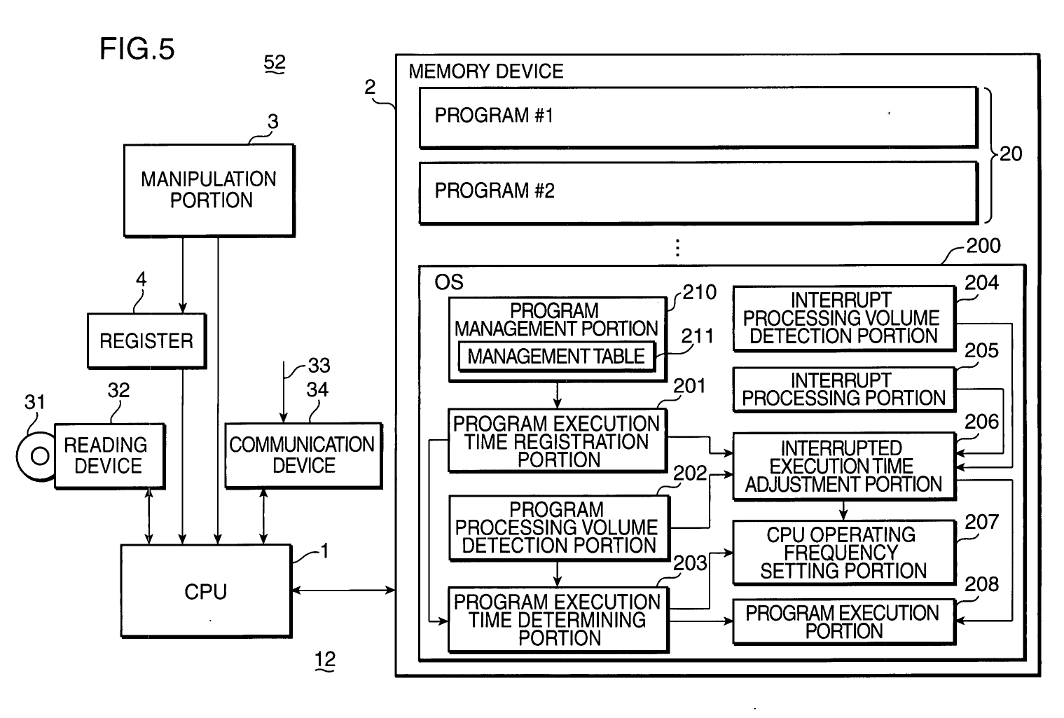

FIG. 5 shows a view showing an information processing device that performs CPU operating frequency control according to a second embodiment of the invention. Referring to the drawing, the configuration including the CPU 1 and the memory device 2 is the same as the first embodiment. Also, like the program 10 of the first embodiment, a program 20 includes respective processings performed by an information processing apparatus 51 written in the form of programs for the information processing apparatus 52. The operating frequency of the CPU 1 is changed by a CPU operating frequency setting portion 207 in an OS 200.

The OS 200 performs the CPU clock control of this embodiment, and therefore includes a program management portion 210, a program execution time registration portion 201, a program processing volume detection portion 202, a program execution time determining portion 203, an interrupt processing volume detection portion 204, an interrupt processing portion 205, an interrupted execution time adjustment portion 206, a CPU operating frequency setting portion 207, and a program execution portion 208. In this embodiment, the program management portion 210, the program execution time registration portion 201, the program processing volume detection portion 202, the program execution time determining portion 203, the interrupt processing volume detection portion 204, the interrupt processing portion 205, the interrupted execution time adjustment portion 206, the CPU operating frequency setting portion 207, the program execution portion 208, and the CPU 1 have the capabilities to operate as a CPU clock control device 12.

The program management portion 210 includes a management table 211. The management table 211 has stored the execution start times, allowable ranges, and so forth of the respective programs in correlation with individual programs #1, #2, and so forth included in the program 20. The program management portion 210 notifies the program execution time registration portion 201 of the execution start times, the allowable ranges, and so forth correlated with the individual programs #1, #2, and so forth designated for execution by the user, for example, via the manipulation portion 3, so that these are registered therein. The program management portion 210 does not necessarily store the execution start times, the allowable ranges, and so forth of all the programs, and it is sufficient to have a capability of correlating the individual programs with requests for the execution times of the programs and allowable ranges of the requests for the execution times of the programs.

As with the program execution time registration portion 101 in the first embodiment, the program execution time registration portion 201 receives information about the requests for the times and the allowable ranges from the program 20, and notifies the program execution time determining portion 203 and the interrupted execution time adjustment portion 206 of the information. Likewise, as with the program processing volume detection portion 102 in the first embodiment, the program processing volume detection portion 202 notifies the program execution time determining portion 203 and the interrupted execution time adjustment portion 206 of the processing volumes necessary to execute the program 20.

As with the program execution time adjustment portion 103 in the first embodiment, the program execution time determining portion 203 determines execution times of the programs in such a manner that a sum of the necessary processing volumes of the programs for each regular time becomes as equal as possible on the basis of the requests for the execution times, the allowable ranges and the necessary processing volumes of the programs.

The interrupt processing volume detection portion 204 notifies the interrupted execution time adjustment portion 206 of a processing volume necessary for a processing (interrupt handler) performed at the occurrence of an interrupt. The processing volume necessary for the interrupt processing can be detected, for example, by estimating the processing volume in advance and delivering the value when the interrupt handler is registered in the OS 200. Alternatively, a processing volume needed for the interrupt processing to be actually performed may be measured so that the necessary processing volume is detected on the basis of the measured volume.

The interrupt processing portion 205 performs a corresponding interrupt processing when an interrupt signal is generated, and notifies the interrupted execution time adjustment portion 206 of the occurrence of the interrupt processing at the same time.

As with the program execution time determining portion 203, the interrupted execution time adjustment portion 206 determines times of executions of the programs in such a manner that a sum of the necessary processing volumes of the programs for each regular time becomes as constant as possible time-independently on the basis of the requests for the execution times, the allowable range and the necessary processing volumes of the programs. It should be noted, however, that the interrupted execution time adjustment portion 206 determines the program execution times only when the occurrence of an interrupt is notified from the interrupt processing portion 205. Also, the program execution times are determined by adding a processing volume of the interrupt processing notified from the interrupt processing volume detection portion 204 as a processing to be performed at the interrupt occurrence time and then by making the processing volumes per unit time as equal as possible. In other words, the execution times of the programs are determined again so that the processing volumes are smoothed by taking into account the processing volume needed for the interrupt processing.

As with the CPU operating frequency setting portion 104 in the first embodiment, the CPU operating frequency setting portion 207 determines the operating frequency of the CPU on the basis of the processing volume that is smoothed by the program execution time determining portion 203 and necessary for each unit time. The CPU operating frequency setting portion 207 sets this operating frequency in the CPU 1 by controlling a voltage applied to the CPU 1. Further, when the interrupted execution time adjustment portion 206 determines the program execution times again, the CPU operating frequency setting portion 207 determines the CPU operating frequency on the basis of the processing volumes smoothed by the interrupted execution time adjustment portion 206. In short, the CPU operating frequency setting portion 207 sets the CPU operating frequency on the basis of the result of the latest smoothing operation. As a result, a variation of the set operating frequency is lessened in comparison with a case where the CPU operating frequency setting portion 207 does not perform the smoothing operation, and power consumed by the CPU can be therefore reduced. In addition, when the interrupt processing is performed, the CPU operating frequency setting portion 207 determines the CPU operating frequency on the basis of the smoothed necessary processing volumes by taking into account the interrupt processing. It is thus possible to use the most appropriate CPU operating frequency even when an interrupt occurs.

The program execution portion 208 executes the individual programs #1, #2, and so forth included in the program 20 at the execution times determined by the program execution time determining portion 203, using the CPU 1 that operates at the operating frequency set by the CPU operating frequency setting portion 207. However, when the interrupted execution time adjustment portion 206 determines the program execution times again, the program execution portion 208 executes the program 10 at the execution times determined again. In short, the program execution portion 208 executes the program 10 according to the latest determination by taking the occurrence of an interrupt into account.

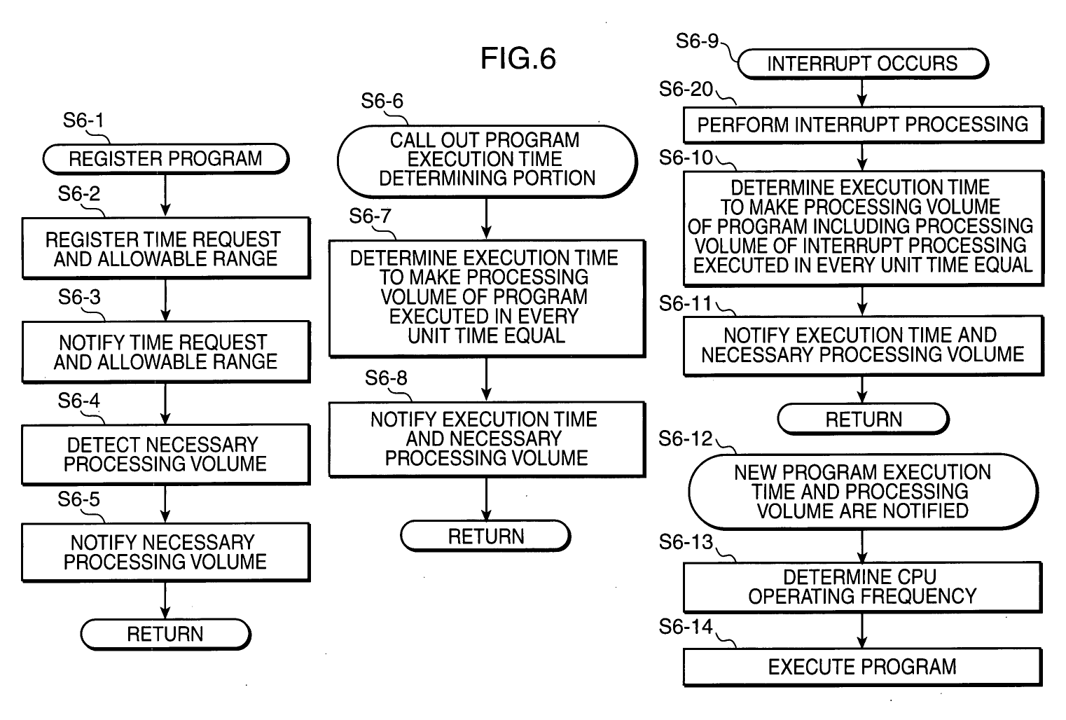

FIG. 6 is a flowchart detailing the operations of the CPU clock control device of this embodiment. Step S6-1 through Step S6-5 are steps of registering the time requests and the allowable ranges of the programs and the step of detecting processing volumes, and they are the same as the Step S2-1 through Step S2-5 of the first embodiment (FIG. 2).

Step S6-6 is the step of calling out the program execution time determining portion 203, and it is the same as the Step S2-6 of the first embodiment. Also, Step S6-7 is the same as Step S2-7 of the first embodiment. In Step S6-8, the program execution time determining portion 203 notifies the CPU operating frequency setting portion 207 and the program execution portion 208 of the determined execution times and necessary processing volumes.

Step S6-9 through Step S6-11 are the flow of processings performed by the interrupt processing portion 205 and the interrupted execution time adjustment portion 206. Herein, the processing volume of the interrupt processing is not shown in the drawing on the assumption that it has been detected previously. In Step S6-9, an interrupt occurs and the CPU 1 reads a register 4 to notify the interrupt processing portion 205 of the requested interrupt. Upon receipt of the notice, the interrupt processing portion 205 performs the interrupt processing requested in Step S6-20. Steps S6-10 and S6-11 are processings performed when the interrupt occurs. Step S6-10 is the step performed by the interrupted execution time adjustment portion 206 to determine the program execution times by taking into account the processing volume necessary for the interrupt processing. Step S6-10 is the same as Step S6-7 except that the interrupt processing is deemed as a processing necessary at the current time. In Step S6-11, the interrupted execution time adjustment portion 206 notifies the CPU operating frequency setting portion 207 and the program execution portion 208 of the execution times and the necessary processing volumes thus determined.

Step S6-12 through Step S6-14 are the flow of processings performed by the CPU operating frequency 207 and the program execution portion 208. Step S6-12 is the step of notifying the program execution times and the necessary processing volumes in the case of Step S6-8 (when the interrupt does not occur) or in S6-11 (when the interrupt occurs), and Step S6-13 and Step S6-14 are performed when Step S6-12 is performed. Step S6-13 is the step performed by the CPU operating frequency setting portion 207 to determine the CPU operating frequency on the basis of the notified necessary processing volumes. Also, in Step S6-14, the program execution portion 208 executes the program 20 at the execution times determined in Step S6-8 or Step S6-11.

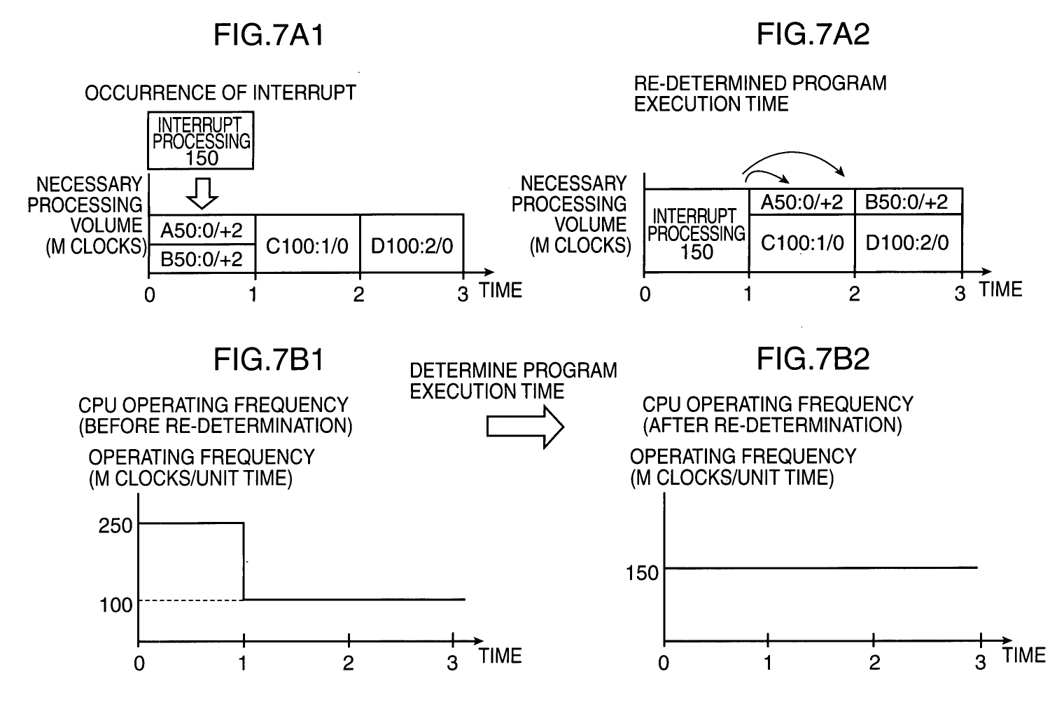

FIG. 7 shows one example of processings performed by the CPU clock control device of this embodiment. As with FIGS. 3A1 and 3A2, FIGS. 7A1 and 7A2 use the ordinate for the necessary processing volume (M clocks) and the abscissa for the time (unit: arbitrary). Also, as with FIGS. 3B1 and 3B2, FIGS. 7B1 and 7B2 use the ordinate for the operating frequency (M clocks/unit time) and the abscissa for the time (unit: arbitrary).

FIG. 7A1 shows a state where an interrupt processing having a necessary processing volume of 150 occurs after the execution times of the programs are determined as the result of Steps S6-1 through S6-8 of FIG. 6. When the interrupt occurs, Steps S6-9, S6-20, and S6-10 are performed, and the interrupted execution time adjustment portion 206 determines the execution times of the programs again. In this example, the execution start time is 0 and the allowable range is +2 for both programs A and B. Hence, although “an execution at the time 0 is requested”, a delay up to the time 2 is allowed. It is therefore understood that it is sufficient for the programs to be executed until the time 2. On the contrary, because the allowable range is 0 for both programs C and D, they have to be executed at the time 1 and the time 2, respectively.

As has been described, the interrupted execution time adjustment portion 206 changes the times of executions of the programs A and B, so that they are executed at the time 1 and the time 2, respectively, as is shown in FIG. 7A2. FIGS. 7B1 and 7B2 show the operating frequencies of the CPU 1 converted from the necessary processing volumes on the ordinate shown in FIGS. 7A1 and 7A2, respectively. As can be understood from FIG. 7B1, in a case where an interrupt to be executed between the times 0 and 1 occurs, “250” is necessary as the operating frequency of the CPU 1 unless any change is made. However, because the interrupt processing is completed after the time 1, “100” is set as the operating frequency of the CPU 1. As has been described, the operating frequency of the CPU 1 varies markedly, and power consumption of the CPU 1 is correspondingly increased unless the interrupted execution time adjustment portion 206 changes the times of executions of the programs A and B.

On the contrary, when the interrupted execution time adjustment portion 206 changes the times of executions of the programs A and B, as is shown in FIG. 7B2, necessary processing volumes to execute the programs are made equal, and a variation of the operating frequency of the CPU 1 is lessened. Power consumption of the CPU 1 can be therefore reduced. Also, in this instance, the respective programs are performed within the allowable ranges.

As with the first embodiment, in this embodiment, the program 20 does not necessarily include all the processings performed by the information processing apparatus, either, and it may include a particular part. Also, the time requests and the allowable ranges may be registered for a part of the programs.

In this embodiment of the invention, the program management portion 210, the program execution time registration portion 201, the program processing volume detection portion 202, the program execution time determining portion 203, the interrupt processing volume detection portion 204, the interrupt processing portion 205, the interrupted execution time adjustment portion 206, the CPU operating frequency setting portion 207, and the program execution portion 208 are provided in the OS 200. However, they can be provided on the outside of the OS 200.

### Third Embodiment

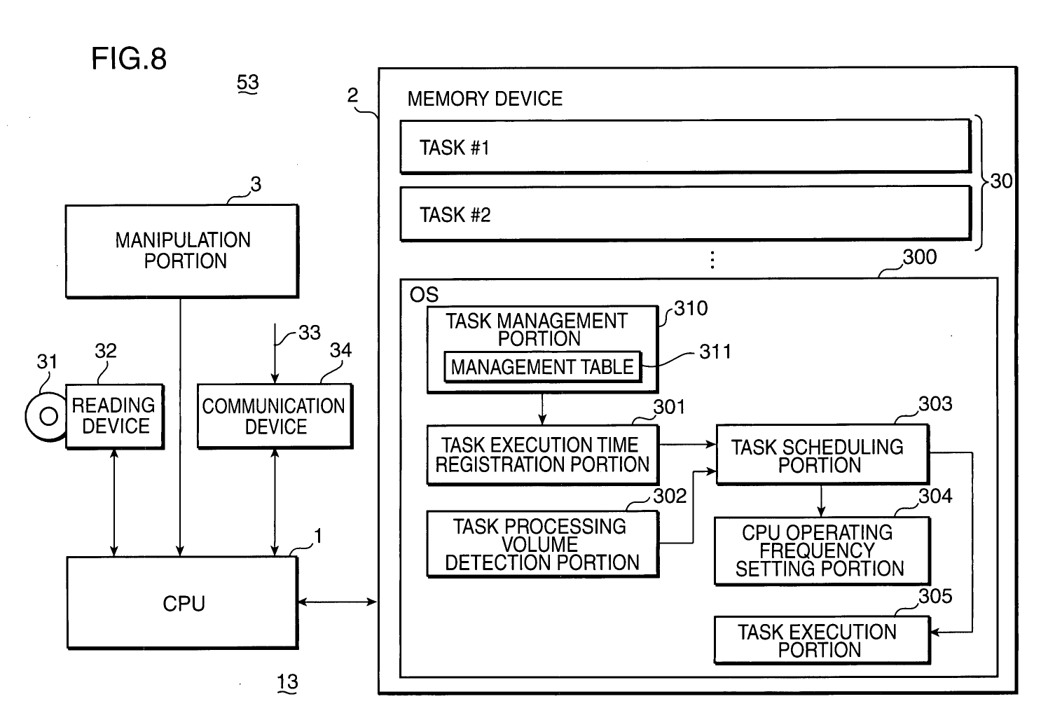

FIG. 8 is a view showing an information processing apparatus that performs CPU operating frequency control according to a third embodiment of the invention. Referring to the drawing, the configuration including the CPU 1 and the memory device 2 is the same as the first embodiment.

Respective tasks #1, #2, and so forth included in a task 30 are the units in which the information processing apparatus performs processings, and they are executed by an OS 300 in a time division manner in order of assigned priorities. A task is classified into “a process” and “a thread” depending on the OS. A process is a processing unit controlled to avoid mutual interference, and a word processor and a spreadsheet program are known for a general computer. A thread is a minimum unit of a processing when the OS performs processings in one application in parallel, and it is the unit of a consecutive processing within the process. One process can comprise more than one thread.

A processing mode for performing plural tasks in parallel as has been described is referred to as a multi-task processing, and it is a processing mode generally used. Descriptions will be given on the assumption that the information processing apparatus of this embodiment performs the multi-task processing. Also, in this specification, the programs in the first and second embodiments are comprehensive programs including tasks and the like of this embodiment, and they are not necessarily the minimum execution unit. In short, both a single task and a set of plural tasks can be referred to as a program.

The OS 300 performs the CPU clock control of this embodiment, and therefore includes a task management portion 310, a task execution time registration portion 301, a task processing volume detection portion 302, a task scheduling portion 303, a CPU operating frequency setting portion 304, and a task execution portion 305. In this embodiment, the task management portion 310, the task execution time registration portion 301, the task processing volume detection portion 302, the task scheduling portion 303, the CPU operating frequency setting portion 304, the task execution portion 305, and the CPU 1 have the capabilities to operate as a CPU clock control device 13.

The task management portion 310 includes a management table 311. The management table 311 has stored the execution start times, allowable ranges, and so forth of respective tasks in correlation with individual tasks #1, #2, and so forth included in the task 30. The task management portion 310 notifies the task execution time registration portion 301 of the execution start times, the allowable ranges, and so forth correlated with the individual tasks #1, #2, and so forth designated for execution by the user, for example, via the manipulation portion 3, so that these are registered therein. The task management portion 310 does not necessarily store the execution start times, the allowable ranges, and so forth of the tasks, and it is sufficient to have a capability of correlating the individual tasks with requests for execution times of the tasks and allowable ranges of the requests for the execution times of the tasks.

The task execution time registration portion 301 registers information about the requests for the execution times and the allowable ranges of tasks according to an instruction from the task management portion 310, and notifies the task scheduling portion 303 of the information. Herein, the request for the execution time of task means, for example, a request for the start time of the task, a request for the end time, an execution cycle, etc. A selection as to which requests to register can be designed according to a task scheduling method of the OS 300. Likewise, a selection as to which allowable ranges to register and its notation system can be designed according to the task scheduling method of the OS 300.

The task processing volume detection portion 302 detects processing volumes necessary for respective tasks, and notifies the task scheduling portion 303 of the processing volumes. The processing volumes can be detected, for example, by delivering the processing volumes that have been estimated previously to the OS 300 when the method of scheduling tasks is specified. Alternatively, processing volumes needed for tasks to be actually executed may be measured, so that the processing volumes are determined on the basis of the measured processing volumes.

The multi-task information processing apparatus 53 normally includes an interface that specifies the method of scheduling tasks. The interface is, for example, the one that requests a periodical execution of a task by calling out a function to specify a cycle in the form of an augment of the function.

Different from this method, the cycle may be specified by performing a specific volume of processings for each regular time for a particular task. When such an interface is provided, it is possible to use the specification as the requests for the execution times or the detection of processing volumes.

The task scheduling portion 303 performs scheduling of tasks. The task scheduling portion 303 schedules tasks to the extent that the requests for times and the allowable range are met. At the same time, it schedules tasks in such a manner that a sum of the necessary processing volumes of tasks for each regular time is made as equal as possible.

The CPU operating frequency setting portion 304 determines the operating frequency of the CPU on the basis of the processing volumes necessary for each unit time and smoothed by the task scheduling portion 303. The CPU operating frequency setting portion 304 then sets this operating frequency in the CPU 1 by controlling a voltage applied to the CPU 1. Processing volumes for each unit time requested for the task 30 to be executed are smoothed by the task scheduling portion 303. Hence, in comparison with a case where the smoothing operation is not performed, a variation of the operating frequency set by the CPU operating frequency setting portion 304 is lessened, and power consumed by the CPU 1 can be therefore reduced. The task execution portion 305 executes the task 30 according to the schedule set by the task scheduling portion 303.

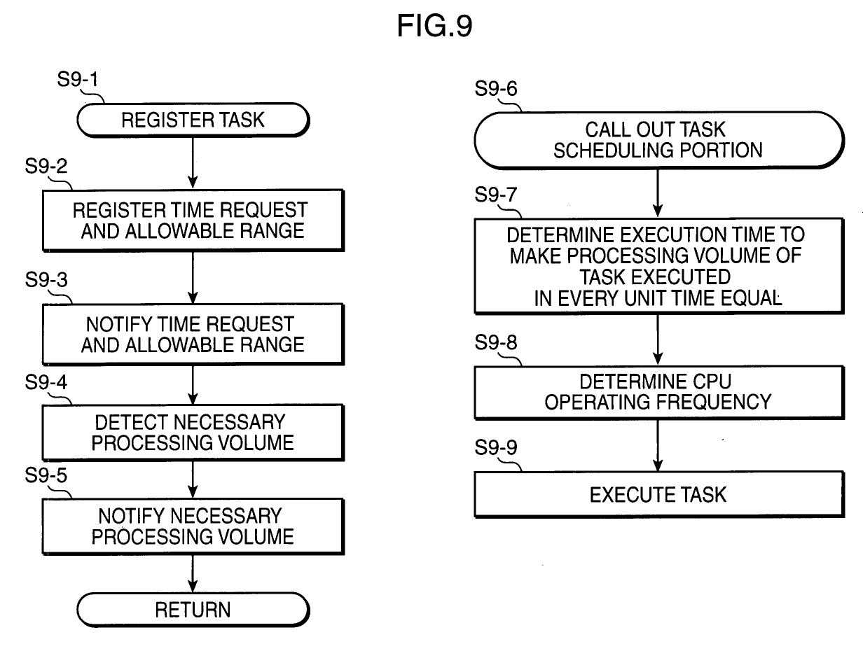

FIG. 9 is a flowchart detailing the flow of processings in this embodiment. In Step S9-1, the task management portion 310 loads tasks to be executed by the information processing device 53 into the memory device 2, for example, from the ROM or the like descried above to be registered therein, for example, by manipulations of the user on the manipulation portion 3. In subsequent Step S9-2, the task management portion 310 registers requests for execution times and allowable ranges of the task 30 thus registered into the task execution time registration portion 301. In Step S9-3, the task execution time registration portion 301 notifies the task scheduling portion 103 of the requests for the execution times and the allowable ranges thus registered.

In Step S9-4, the task processing volume detection portion 302 detects processing volumes necessary for the tasks requested to be executed. As has been described, in Step S9-4, the necessary processing volumes are detected, for example, by calling out the functions from the tasks or by waiting for the program to be executed actually to measure the necessary processing volumes actually. In Step S9-5, the task processing volume detection portion 102 notifies the task scheduling portion 303 of the necessary processing volumes of the tasks thus detected. In the flowchart of FIG. 9, the registration and the notification of the requests for the times and the allowable ranges (S9-2 and S9-3) are performed before the detection and the notification of the necessary processing volumes (S9-4 and S9-5). However, these steps are not necessarily performed in this order. Because these steps are independent, they can be performed in arbitrary order.

Step S9-6 is the step of calling out the task scheduling portion 303. The task scheduling portion 303 may be called out at the timing of normal task scheduling. Alternatively, it may be called out periodically in a particular cycle or it may be called out when a processing of one task is completed.

In S9-7, execution times are determined for all the tasks that are requested to be executed and whose requests for the execution times or the like have been notified to the task scheduling portion 303. As has been described, the task scheduling portion 303 performs scheduling in such a manner that a sum of the necessary processing volumes of respective tasks notified in Step S9-5 per unit time becomes as equal as possible to the extent that the execution time requests and the allowable ranges of the respective tasks notified in Step S9-3 are met.

To determine the execution times in Step S9-7 is a general problem to allocate execution times of the tasks within the limitations, and various algorithms can be used. For example, when the task 30 that needs to be executed includes a relatively small number of tasks, variations of the processing volumes may be compared with one another by listing all the possible patterns of execution times. It should be noted, however, that perfect equalization is not necessarily achieved. Because power consumption can be reduced correspondingly by lessening a variation of the CPU operating frequency, even when equalization is not perfect, the power consumption saving advantage can be achieved correspondingly with the equalization. Hence, the advantage can be achieved, for example, by merely moving the execution of one program to another time from a time at which the necessary processing volume becomes the largest.

Because equalization to some extent is possible even when necessary processing volumes of programs are approximate values instead of exact values, the power consumption reducing effect can be achieved in this case, too. Further, the execution times are not necessarily determined for all the tasks, and it is sufficient to determine execution times from the current time to a certain time later. Because a computation time is necessary for equalization, it is possible to design the extent to which the equalization can be precise according to the purpose of use and the use environment of the information processing apparatus 53.

In Step S9-8, upon receipt of the execution times determined by the task scheduling portion 303, the CPU operating frequency setting portion 304 determines the operating frequency of the CPU 1, and sets this operating frequency in the CPU 1. In Step S9-9, the task execution portion 305 executes tasks requested to be executed. The tasks are executed at times determined by the task scheduling portion 303. Hence, in practice, Step S9-9 is not performed immediately after Step S9-8 is completed, and it is performed when the determined execution time has come.

An example of actual processings in this embodiment includes those shown as the example of the first embodiment (FIG. 3 and FIG. 4). In short, scheduling of the tasks to which execution times are specified can be performed in the same manner as in FIG. 3 and FIG. 4. In particular, the scheduling similar to that in FIG. 4 is the scheduling to execute a particular task (program A in FIG. 4) periodically. However, it is also the scheduling for performing a specific pre-set processing volume (50 in FIG. 4) in regular cycles (cycle 2 in FIG. 4) without fail.

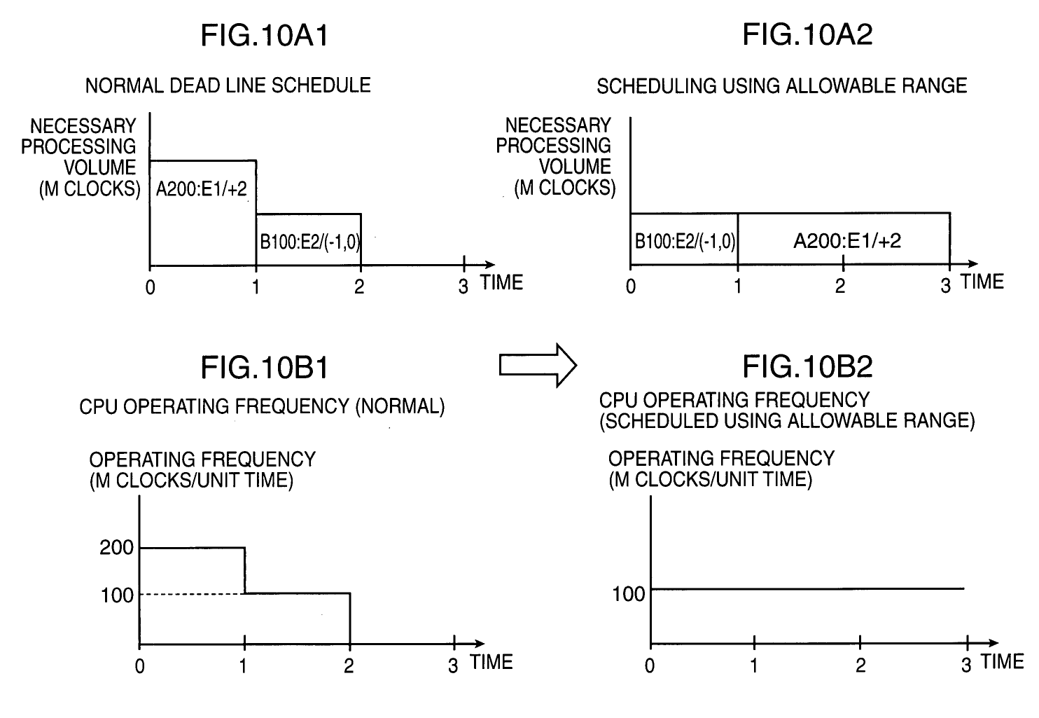

FIG. 10 shows another example of processings performed by the CPU clock control device in this embodiment. The example of FIG. 10 will be described on the assumption that a dead line schedule of the tasks is performed. The dead line schedule is to specify times at which processing of the tasks have to be completed, so that tasks are executed in descending order of times (deadline).

FIG. 10A1 is a view schematically showing normal scheduling to perform tasks in descending order of requested dead lines. A square block represents a task, and two tasks A and B need to be scheduled in FIG. 10A1. A value added at the end of a capital letter indicating the task name indicates the necessary processing volume of the task, and values added to the end of the necessary processing volume indicate the execution time request and the allowable range. In this example, the request for the execution time is the dead line, and a capital letter E indicates being the dead line. The allowable range is an allowable range of the dead line, that is, it indicates to which extent a gain or a delay from the dead line is allowed.

In the case of the task A, the necessary processing volume is 200, the dead line is 1, and the allowable range is +2. It means that the task A is requested to end by the time 1, but it is allowed to end at the time 3 at the latest. In the case of the task B, the necessary processing volume is 100, the dead line is 2, and the allowable range is (−1, 0). This allowable range (−1, 0) means that the task may end between a time one time ahead the dead line and the time of the specified dead line. More specifically, the task B is requested to end by the time 2, but it is allowed to end between the time 1 and the time 2. Also, FIG. 10A1 shows the information notified to the task scheduling portion 303 as the result of Step S9-1 and Step S9-5 of FIG. 9.

FIG. 10B1 shows the CPU operating frequency when the tasks A and B are performed according to the schedule in FIG. 10A1 to complete the respective processings at the minimum necessary operating frequency without generating an idle period.

FIG. 10A2 shows the result of the scheduling performed by the task scheduling portion 303 in Steps S9-6 and S9-7. Herein, the scheduling is performed to make the processing volume required for each time as smooth as possible.

FIG. 10B2 shows the CPU operating frequency when tasks in FIG. 10A2 are executed. In comparison with FIG. 10B1, a variation of the operating frequency is lessened in FIG. 10B2, and power consumption of the CPU during this period can be therefore reduced. Also, in this instance, the tasks A and B are executed within the allowable ranges.

As has been described, in this embodiment, scheduling is enabled in various manners by specifying the requests for the execution times, the allowable ranges and the necessary processing volumes. It should be noted, however, that requests for execution times are not necessarily registered for the entire task 30 of this embodiment. Even when the processing volumes are smoothed for a part of all the tasks, it is possible to achieve the advantage to some extent, albeit restrictively.

As with the second embodiment, in this embodiment, too, it is possible to include the interrupt processing volume detection portion, the interrupt processing portion, and the interrupted execution time adjustment portion that performs scheduling of tasks again at the occurrence of an interrupt. In this case, tasks are scheduled again at the occurrence of an interrupt in such a manner that processing volumes are made equal by taking a processing volume of the interrupt processing into account. The occurrence of an interrupt can be therefore supported.

In this embodiment of the invention, the task management portion 310, the task execution time registration portion 301, the task processing volume detection portion 302, the task scheduling portion 303, the CPU operating frequency setting portion 304, and the task execution portion 305 are provided in the OS 300. However, they can be provided on the outside of the OS 300.

### Fourth Embodiment

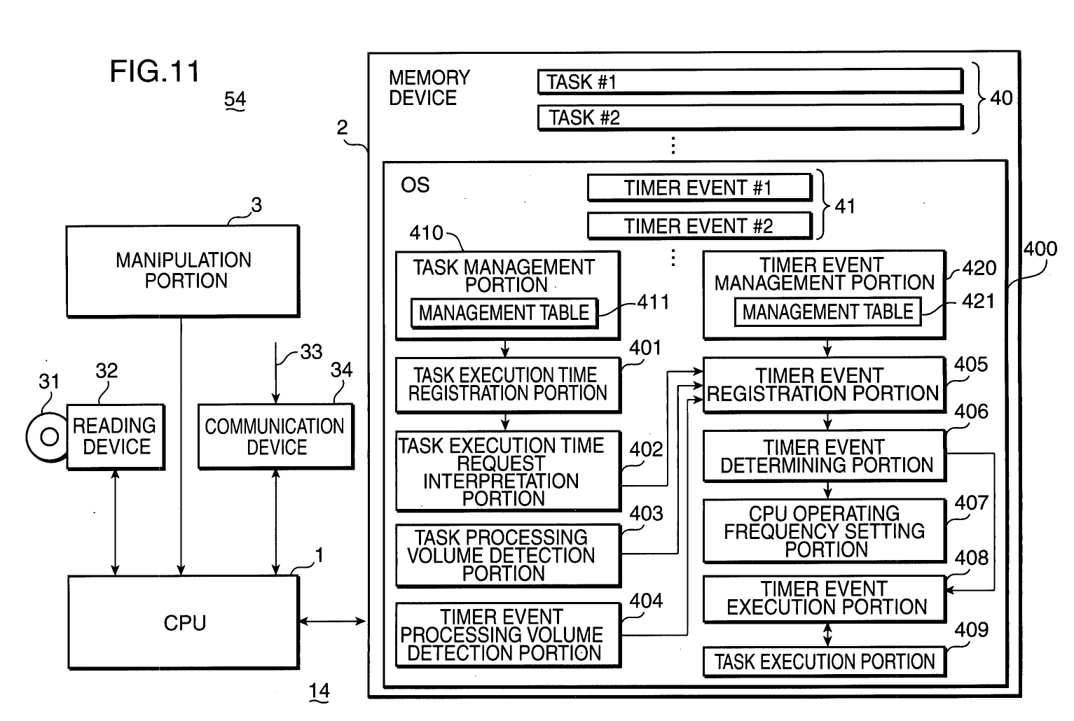

FIG. 11 is a view showing an information processing apparatus that performs CPU operating frequency control according to a fourth embodiment of the invention. An information processing apparatus 54 includes at least one CPU 1 and a memory device 2. Referring to the drawing, the configuration including the CPU 1 and the memory device 2 is the same as the first embodiment. Also, referring to the drawing, the configuration that the memory device 2 stores a task 40 is the same as the third embodiment. The operating frequency of the CPU 1 is changed and the task 40 is controlled by an OS 400.

A timer event 41 is a processing registered in the OS 400 by specifying a time at which the timer event 41 is executed. The capability of registering and executing the timer event 41 involves real-time processings, and it is therefore achieved in many OS's. The timer event 41 is available as a single unit; however, in this embodiment, descriptions will be given on the assumption that individual timer events #1, #2, and so forth included in the timer event 41 wake up individual tasks #1, #2, and so forth included in the corresponding task 40. It should be noted, however, that the timer events #N and the task #N (N=1, 2, 3, and so forth) do not necessarily correspond to each other, and a correspondence in the combination is arbitrary.

The OS 400 performs the CPU clock control of this embodiment, and therefore includes a task management portion 410, a timer event management portion 420, a task execution time registration portion 401, a task execution time request interpretation portion 402, a task processing volume detection portion 403, a timer event processing volume detection portion 404, a timer event registration portion 405, a timer event adjustment portion 406, a CPU operating frequency setting portion 407, a timer event execution portion 408, and a task execution portion 409. In this embodiment, the task management portion 410, the timer event management portion 420, the task execution time registration portion 401, the task execution time request interpretation portion 402, the task processing volume detection portion 403, the timer event processing volume detection portion 404, the timer event registration portion 405, the timer event adjustment portion 406, the CPU operating frequency setting portion 407, the timer event execution portion 408, the task execution portion 409, and the CPU 1 have the capabilities to operate as a CPU clock control device 14.

The task management portion 410 includes a management table 411. The management table 411 has stored execution start times, allowable ranges, and so forth of respective tasks in correlation with individual tasks #1, #2, and so forth included in the task 40. The task management portion 410 notifies the task execution time registration portion 401 of the execution start times, the allowable ranges, and so firth correlated with the individual tasks #1, #2, and so forth designated for execution by the user, for example, via the manipulation portion 3, so that these are registered therein. Herein, the task management portion 410 does not necessarily store the execution start times, the allowable ranges, and so forth of the tasks, and it is sufficient to have a capability of correlating the individual tasks with the requests for the execution times of the tasks and the allowable ranges of the requests for the execution times of the tasks.

The timer event management portion 420 includes a management table 421. The management table 421 has stored whether the timer event wakes up the task. The timer event management portion 420 instructs the timer event registration portion 405 to receive a processing volume needed for the timer event from the timer event processing volume detection portion 404, and when the timer event is found to be the one that wakes up the task with reference to the management table 421, it further receives a processing volume necessary for the task corresponding to the timer event from the task processing volume detection portion 403.

The task execution time registration portion 401 has the same capability as the task execution time registration portion 301 of the third embodiment. The task execution time registration portion 401 registers information about the requests for the execution times and the allowable ranges of the tasks and notifies the task execution time request interpretation portion 402 of the information according to an instruction from the task management portion 410.

The task execution time request interpretation portion 402 determines the timer event 41 that performs task control so that the requests for the execution times of the task 40 notified from the task execution time registration portion 401 are met. For example, when the task #1 is requested to start execution at a specific time, the timer event #1 that wakes up the task #1 is executed at that time. Because the control of the task 40 using the timer event 41 as described above is normally performed at present, the timer event used for the task control of this embodiment is performed in the same manner.

In addition, the task execution time request interpretation portion 402 finds the allowable range of the execution time of the timer event 41 for the task control from the allowable ranges of the requests for the execution times of the task 40 notified from the task execution time registration portion 401. For example, when a delay of a certain time is allowed for the execution start times of the task 40 as the allowable range, this time is used as the allowable range of the execution start time of the timer event 41 that wakes up the task 40. When a periodic task execution is requested, the timer event 41 that wakes up the task 40 is executed in a requested cycle, and when the task execution cycle has an allowable range, this allowable range is used as the allowable range of the execution cycle of the timer event. The task execution time request interpretation portion 402 requests the timer event registration portion 405 to register the determined timer event 41 for the task control together with the execution times and the allowable ranges.

The task processing volume detection portion 403 has the same capability as the task processing volume detection portion 302 of the third embodiment. The task processing volume detection portion 403 notifies the timer event registration portion 405 of the detected processing volumes necessary for the tasks upon receipt of the request from the timer event registration portion 405.

Upon receipt of a request from the timer event registration portion 405, the timer event processing volume detection portion 404 detects a processing volume necessary for the timer event, and notifies the timer event registration portion 405 of the necessary processing volume. As with the task processing volume detection portion 403, the necessary processing volume can be detected, for example, by notifying a necessary processing volume estimated in advance within the respective timer events, or determined on the basis of processing volumes measured actually by executing the respective timer events actually.

The timer event registration portion 405 registers the timer events requested by the task execution time request interpretation portion 402 together with the requests for the execution times and the allowable ranges of the timer events. Also, the timer event registration portion 405 may be of a configuration by which a timer event irrelevant to the tasks can be registered at a request from the outside. In this case, too, the request for the timer event execution time and the allowable range may be registered as well.

Moreover, upon receipt of an instruction from the timer event management portion 420, the timer event registration portion 405 further receives the processing volume necessary for the timer event from the timer event processing detection portion 404, and when the timer event is the one that wakes up the tasks, it further receives the processing volume necessary for the task corresponding to the timer event from the task processing volume detection portion 403. The timer event registration portion 405 then calculates a processing volume as a sum of the necessary processing volume of the timer event itself and a necessary processing volume of the task executed by the timer event, and notifies the timer event determining portion 406 of information about the timer event including the calculated processing volume.

The timer event determining portion 406 determines the time at which the timer event is actually executed on the basis of the request for the execution time and the allowable range of the timer event notified from the timer event registration portion 405, and further a processing volume necessary for the task when the task is executed by the timer event as well as the processing volume necessary for the timer event itself. In this instance, the timer event determining portion 406 determines the time at which the timer event is executed to the extent that the request for the execution time and the allowable range of the timer event are met. At the same time, the timer event determining portion 406 determines the time at which the timer event is executed in such a manner that a processing volume that becomes necessary by executing the timer event, that is, a sum of the processing volume for the timer event itself and the processing volume of the task executed by the timer event for each regular time is made as equal as possible. A sum of the processing volume for the timer event and the processing volume for an execution of the task necessary for each regular time can be thus smoothed.

The CPU operating frequency setting portion 407 determines the operating frequency of the CPU on the basis of the processing volume smoothed by the timer event determining portion 406. The CPU operating frequency setting portion 407 then sets this operating frequency in the CPU 1 by controlling a voltage applied to the CPU 1. The timer event execution portion 408 executes the timer event 41 at the execution times determined by the timer event determining portion 406, using the CPU 1 that operates at the operating frequency set by the operating frequency setting portion 407. The task execution portion 409 executes the task 40 when the timer event executed by the timer event execution portion 408 is the one that wakes up the task 40.

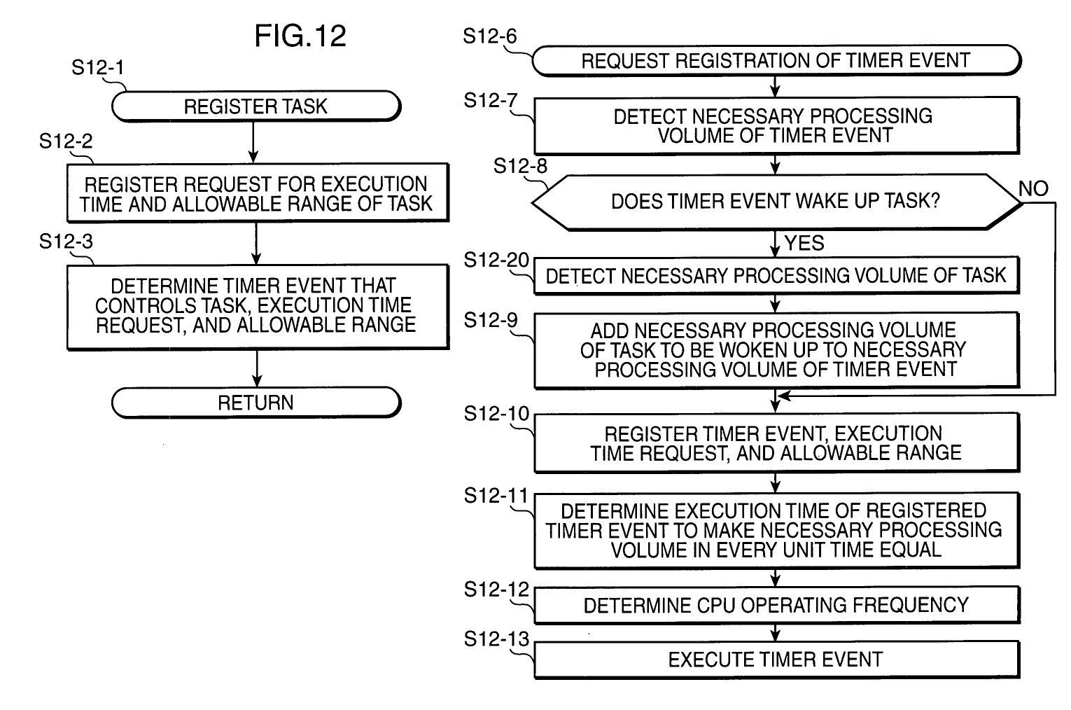

FIG. 12 is a flowchart detailing operations of the CPU clock control device of this embodiment. Step S12-1 through Step S12-5 show the flow of processings by the task management portion 410, the task execution time registration portion 401, the task execution time request interpretation portion 402, and the task processing volume detection portion 403. Step S12-6 and Step S12-7 show the flow of processings by the timer event management portion 420, the timer event registration portion 405, the timer event determining portion 406, the CPU operating frequency setting portion 407, and the timer event execution portion 408.

In Step S12-1, the task 40 to be executed by the information processing apparatus 54 is loaded in the memory device 2 to be registered therein, for example, from the ROM or the like as described above, for example, by manipulation of the user on the manipulation portion 4. In Step S12-2, the task management portion 410 registers the requests for the execution times and the allowable ranges of the registered task 40 in the task execution time registration portion 401. In Step S12-3, the task execution time request interpretation portion 402 determines the timer event 41 that controls the task 40 in such a manner that the requests for the execution times and the allowable ranges of the task 40 registered in the task execution time registration portion 401 are met as well as the requests for the execution times and allowable ranges of the timer event 41.

For example, in a case where the task is requested to wake up one second later, and a delay of 0.1 second is allowed for the wakeup time, the task execution time request interpretation portion 402 determines so that the timer event that wakes up the task is executed one second later with a delay within 0.1 second.

Step S12-6 is the step of requesting the registration of the timer event, and Step S12-7 through Step S12-13 are executed when the registration of the timer event is requested. In Step S12-7, a processing volume of the timer event requested to be registered is detected. This can be achieved as the timer event registration portion 405 receives the processing volume of the timer event from the timer event processing volume detection portion 404. It should be noted, however, that Step S12-7 is not necessarily performed at this point in time, and it can be performed at any point in time as long as before the information about the processing volume of the timer event becomes necessary.

In Step 12-8, the timer event management portion 420 refers to the management table 421 to judge whether the timer event requested to be registered in the timer event registration portion 405 wakes up the task. When the result shows that the timer event requested to be registered wakes up the task, the timer event registration portion 405 receives a processing volume necessary to execute the task from the task processing volume detection portion 403 in Step S12-20. It should be noted, however, that Step S12-20 is not necessarily performed at this point in time, and it can be performed at any point in time as long as the information about the necessary processing volume of the task becomes necessary.

In subsequent Step 12-9, the timer event registration portion 405 calculates a total necessary processing volume by adding the necessary processing volume of the task to be woken up to the necessary processing volume of the timer event itself. In short, the necessary processing volume of the task is calculated as the processing volume necessary to execute the timer event. In Step S12-10, the timer event registration portion 405 registers the timer event transmitted from the timer event management portion 420 together with the execution time request and the allowable range. The timer event registration portion 405 then notifies the timer event determining portion 406 of information including a total necessary processing volume thus calculated.

In Step 12-11, the timer event determining portion 406 determines execution times in such a manner that a sum of the necessary processing volumes of the respective timer events per unit time becomes as equal as possible to the extent that the time requests and the allowable ranges of the respective timer events are met. In other words, the necessary processing volume of the timer event includes the processing volume necessary for the task because it wakes up the task, and all the processing volumes of the timer events and the tasks woken up by the timer events are therefore made equal in Step 12-11.

In Step S12-12, the CPU operating frequency setting portion 407 determines the operating frequency of the CPU on the basis of the processing volume smoothed by the timer event determining portion 406. The CPU operating frequency setting portion 407 sets this operating frequency in the CPU 1 by controlling a voltage applied to the CPU 1. Finally, in Step S12-13, the timer event execution portion 408 executes the registered timer events. However, because the timer event takes place at the specified time, in practice, Step S12-13 is not executed immediately after Step S12-12, and it is executed when an appropriate time has passed.

An example of an actual application of this embodiment includes management using cues for each time at which the timer event is executed. When the timer event is registered, the cue is recorded together with the execution time, the allowable range, and the necessary processing volume (including that of the task) (Step S12-1 through Step S12-5 and Steps S12-6 through S12-10). The cue is scanned each time a new timer event is registered, and cues are recombined within the allowable range so that the necessary processing volumes at the respective times become equal to determine the CPU operating frequency at each time (Steps S12-11 and S12-12). The timer events are executed in order of recombined cues (Step S12-13), and the CPU is driven at the operating frequencies determined at the same time at the respective times.

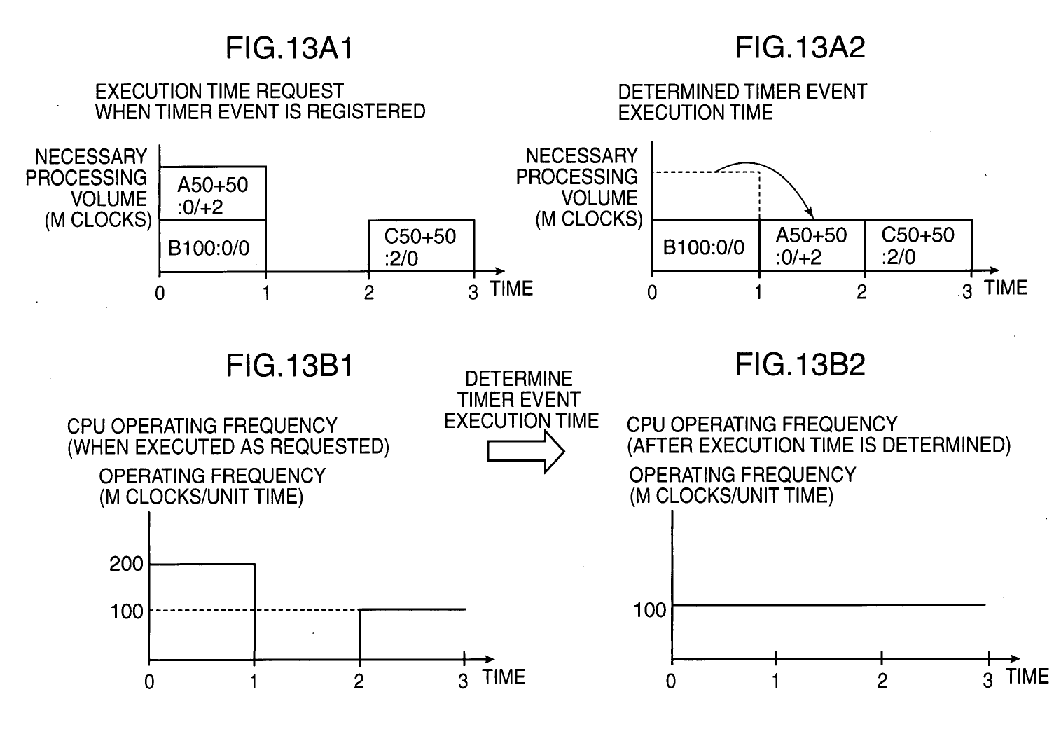

FIG. 13 shows one example of processings performed by the CPU clock control device of this embodiment. As with FIG. 3A1, FIG. 13A1 is a view schematically showing timer events requested to be executed and execution times requested by the timer events, both of which are directly placed on the time axis. FIG. 13A1 shows information notified to the timer event determining portion 406 as the result when Step S12-1 through Step S12-5 and Step S12-6 through Step S12-10 of FIG. 12 are performed.

Referring to the drawing, a square block indicates a timer event. More specifically, in FIG. 13A1, three timer events A, B, and C are requested. A value added at the end of a capital letter indicating a timer event name indicates a necessary processing volume of the timer event, and values added at the end of the necessary processing volume indicate the execution time request and the allowable range. In the case of a timer event that wakes up a task, a sign “+” is added at the end of the processing volume of the timer event itself together with the processing volume of the task. Hence, in the case of the timer event A, the necessary processing volume of the timer event itself is 50, the processing volume of the task to be woken up is 50, the execution time request is 0, and the allowable range is +2.

For the example of FIG. 13, assume that the timer event and the task request to be executed and a processing to be completed within an interval from the time specified by the value of the execution time request to the following time. In short, in the case of A, it is requested to be executed and a processing to be completed between the times 0 and 1. As with the example of the first embodiment (FIG. 3 and FIG. 4), this state is described as “an execution at the time 0 is requested”. Likewise, the value of the allowable range indicates a range of the variation of the execution time.

FIG. 13B1 shows the operating frequency when the CPU operating frequency is set for the timer events A, B, and C to be executed at the execution times shown in FIG. 13A1 and for respective processings to be performed at the minimum necessary operating frequency at each time without generating an idle period.

FIG. 13A2 shows actual execution times of the timer events determined when Step S12-11 is performed. FIG. 13B2 shows the CPU operating frequency when the timer events shown in FIG. 13A2 are executed. In comparison with FIG. 13B1, a variation of the operating frequency is lessened in FIG. 13B2, and power consumption of the CPU during this period can be therefore reduced. Also, in this instance, the respective timer events are executed within the respective allowable ranges.

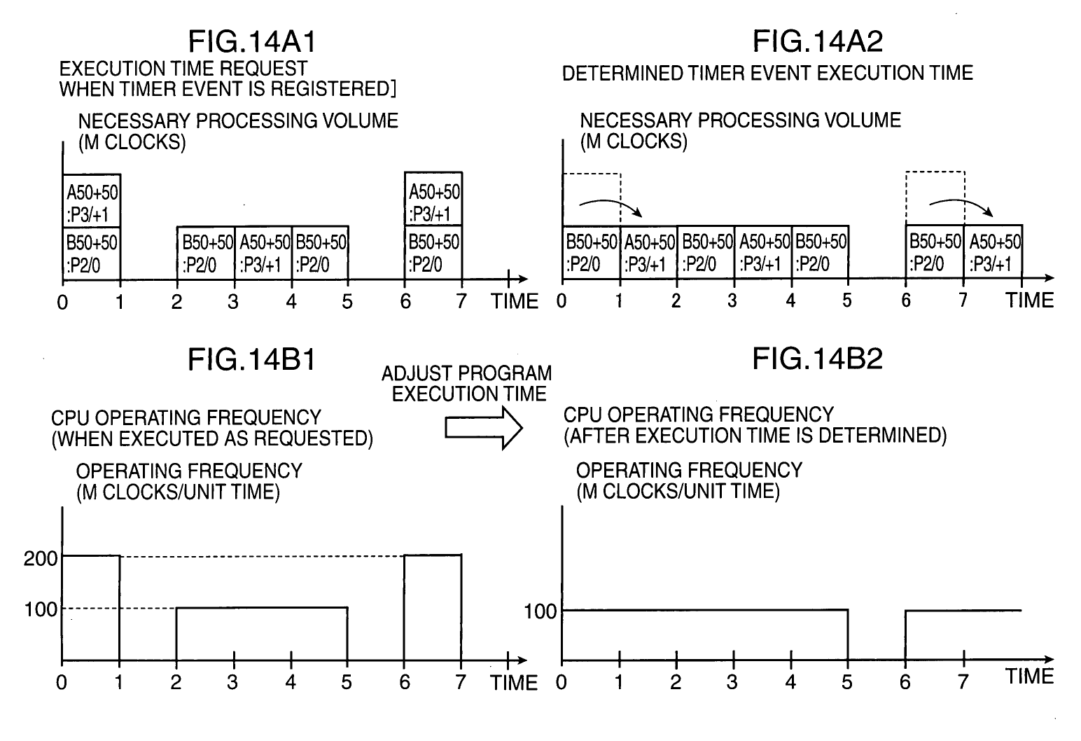

FIG. 14 shows another example of processings performed by the CPU clock control device of this embodiment. As with FIG. 13, FIG. 14A1 is a view schematically showing timer events requested to be executed and the execution times requested by the timer events, both of which are directly placed on the time axis. The timer event A requests a periodical execution in a cycle 3 and the timer event B requests a periodical execution in a cycle 2. These execution time requests are denoted, respectively, by P3 and P2 in FIG. 14A1. Both the timer events A and B wake up tasks each having a processing volume of 50 in addition to the timer event itself having a processing volume of 50. Because a delay by one time is allowed for the time at which the task woken up by the timer event A is executed, the timer event A has an allowable range of +1. On the contrary, no delay is allowed for the time at which a task woken up by the timer event B is executed, and the allowable range of the timer event B is therefore 0.

FIG. 14A2 shows a state after the execution times of the timer events performed by the timer event determining portion 406 are smoothed. In this example, the execution times of the timer event A are changed from the time at which executions are originally requested.

FIGS. 14B1 and 14B2 are views schematically showing operating frequencies when the minimum necessary operating frequency for processing is used. Although the operating frequency is not perfectly made equal in FIG. 14B2, a variation of the operating frequency is lessened in comparison with FIG. 14B1, and power consumption of the CPU can be correspondingly reduced. Also, in this instance, the timer event and the task are executed within the respective allowable ranges.

As has been described, in this embodiment, it is possible to reduce power consumption of the CPU while the requests for the execution times and the allowable ranges of the task and the timer event are met. As with the other embodiments, the allowable ranges are not necessarily registered for all the timer events. Even when processing volumes are smoothed for a part of all the processings, the processing volumes corresponding to that part are smoothed. It is thus possible to achieve the power consumption reducing advantage. Also, in this embodiment, the necessary processing volumes of both the task and the timer event are smoothed; however, the necessary processing volumes are not necessarily smoothed for the both. When either of the necessary processing volumes is sufficiently small, it can be ignored as the influences are minor. For example, when the necessary processing volume of the timer event is sufficiently small with respect to that of the task, the necessary processing volume of the timer event is set to substantially “0”, so that the necessary processing volume of the task alone is smoothed.

As with the second embodiment, in this embodiment, too, it is possible to include the interrupt processing volume detection portion, the interrupt processing portion, and the interrupted execution time adjustment portion that determines the timer event execution times again at the occurrence of an interrupt. In this case, the execution times of the timer events are determined again in such a manner that processing volumes are made equal at the occurrence of an interrupt by taking the processing volume of the interrupt processing into account. It is thus possible to reduce power consumption of the CPU while supporting the occurrence of an interrupt.

In this embodiment of the invention, the task management portion 410, the timer event management portion 420, the task execution time registration portion 401, the task execution time request interpretation portion 402, the task processing volume detection portion 403, the timer event processing volume detection portion 404, the timer event registration portion 405, the timer event determining portion 406, the CPU operating frequency setting portion 407, the timer event execution portion 408, and the task execution portion 409 are provided in the OS 400. However, they can be provided on the outside of the OS 400.

### SUMMARY OF THE EMBODIMENTS

The embodiments of the invention can be summarized as follows.

(1) As has been described, a CPU clock control device of the invention in this application is a CPU clock control device that controls a clock of its own CPU, which preferably includes: a program management portion that loads a program to be executed by the CPU and correlates the program with a request for an execution time of the program and an allowable range of the request for the execution time of the program; a program execution time registration portion that receives the request for the execution time of the program and the allowable range from the program management portion to be registered therein in correlation with the program; a program processing volume detection portion that detects a processing volume necessary to execute the program; a program execution time determining portion that determines an execution start time and a processing volume per unit time of the program in such a manner that the processing volume detected by the program processing volume detection portion is made equal within a specific time range to the extent that the request for the execution time and the allowable range registered in the program execution time registration portion are met; a CPU operating frequency setting portion that determines an operating frequency of the CPU at each time on the basis of the execution start time and the processing volume per unit time of the program determined by the program execution time determining portion, and sets the operating frequency in the CPU; and a program execution portion that makes the CPU operating at the operating frequency set by the CPU operating frequency setting portion execute the program at the execution start time and the processing volume per unit time determined by the program execution time determining portion.

According to this configuration, the program execution time registration portion registers the request for the execution time of the program to be executed by the CPU and the allowable range of the request for the execution time of the program under the control of the program management portion. Herein, the request for the execution time means an execution start time specifying when the program is executed, an end time specifying by what time the processing needs to end, or further an execution cycle when the program is executed periodically. Also, the allowable range means information indicating the extent of a variation allowed for the request for the execution time. For example, it indicates the extent of a gain or a delay allowed for the execution start time or the end time.

The program processing volume detection portion detects a processing volume necessary to execute the program to be executed by the CPU. The program execution time registration portion then notify the program execution time determining portion of the request for the execution time and the allowable range, and the program processing volume detection portion then notify the program execution time determining portion of the necessary processing volume. On the basis of the notified information, the program execution time determining portion determines the execution start time and the processing volume per unit time in such a manner that the processing volume within the specific time range becomes not perfectly equal but as equal as possible to the extent that the request for the execution time and the allowable ranges are met. For example, in a case where two programs having the same processing volume are requested to start execution at the same time while any other program is requested to be executed, the program execution time determining portion adjusts the execution start times in such a manner that one program is executed after the execution of the other program ends.

Subsequently, the CPU operating frequency setting portion determines the operating frequency of the CPU at each time on the basis of the execution start time and the processing volume per unit time of the program determined by the program execution time determining portion, and sets the operating frequency.

Because the program execution portion executes the program by means of the CPU, the program can be executed to the extent that the request for the execution time of the program and the allowable range are met. Further, because the processing volume required for the CPU is made equal, it is possible to reduce the power consumption of the CPU correspondingly.

(2) A CPU clock control device is the CPU clock control device set forth in (1), which preferably further includes: an interrupt processing portion that performs an interrupt processing performed at an occurrence of an interrupt; an interrupt processing volume detection portion that detects a processing volume necessary for the interrupt processing; and an interrupted execution time adjustment portion that determines again the execution start time and the processing volume per unit time of the program when the interrupt processing portion performs the interrupt processing at an occurrence time of the interrupt in such a manner that the processing volume necessary to execute the program and the processing volume of the interrupt processing are made equal within a specific time range to the extent that the request for the execution time and the allowable range registered in the program execution time registration portion are met, wherein the CPU operating frequency setting portion determines the operating frequency of the CPU on the basis of a new processing volume, which is one of the processing volume made equal by the program execution time determining portion and the processing volume made equal by the interrupted execution time adjustment portion, and the program execution portion executes the program at new execution start time and processing volume per unit time, which is one of the execution start time and the processing volume per unit time determined by the program execution time determining portion and the execution start time and the processing volume per unit time determined again by the interrupted execution time adjustment portion.

According to this configuration, when an interrupt occurs, the interrupt processing portion performs the interrupt processing at the occurrence time of the interrupt. A processing volume necessary for the interrupt processing has been detected by the interrupt processing volume detection portion. If no change is made, there is a concern that a processing volume simply increases at the time at which the interrupt occurs, and the power consumption of the CPU increases correspondingly. Hence, when an interrupt occurs, the interrupted time execution adjustment portion determines again the execution start time and the processing volume per unit time of the program by taking into account the processing volume of the interrupt at the time at which the interrupt occurs. In this instance, as with the program execution time determining portion, the interrupted execution time adjustment portion determines the foregoing again to the extent that the request for the execution time and the allowable range are met. It is thus possible to make the processing volume required for the CPU equal and thereby reduce the power consumption of the CPU correspondingly even when an interrupt occurs.

(3) As has been described, a CPU clock control device of the invention in this application is a CPU clock control device that controls a clock of its own CPU, which preferably includes: a task management portion that loads a task to be executed by the CPU and correlates the task with a request for an execution time of the task and an allowable range of the request for the execution time of the task; a task execution time registration portion that receives the request for the execution time of the task and the allowable range from the task management portion to be registered therein in correlation with the task; a task processing volume detection portion that detects a processing volume necessary to execute the task; a task scheduling portion that sets a schedule of an execution start time and a processing volume per unit time of the task in such a manner that the processing volume detected by the task processing detection portion is made equal within a specific time range to the extent that the request for the execution time and the allowable range registered in the task execution time registration portion are met; a CPU operating frequency setting portion that determines an operating frequency of the CPU on the basis of the execution start time and the processing volume per unit time of the task scheduled by the task scheduling portion, and sets the operating frequency in the CPU; and a task execution portion that makes the CPU operating at the operating frequency set by the CPU operating frequency setting portion execute the task according to the schedule set by the task scheduling portion.

According to this configuration, the task execution time registration portion registers the request for the execution time of the task to be executed by the CPU and the allowable range of the request for the execution time of the task under the control of the task management portion. Herein, the request for the execution time means an execution start time specifying when the task is executed, an end time specifying by what time the processing needs to end, or further an execution cycle when the task is executed periodically. Also, the allowable range means information indicating the extent of a variation allowed for the request for the execution time. For example, it indicates the extent of a gain or a delay allowed for the execution start time or the end time.

The task processing volume detection portion detects a processing volume necessary to execute the task to be executed by the CPU. The task execution time registration portion notify the task scheduling portion of the request for the execution time and the allowable range, and the task processing volume detection portion notify the task scheduling portion of the necessary processing volume. On the basis of the notified information, the task scheduling portion determines the execution start time and the processing volume per unit time in such a manner that the processing volume within the specific time range becomes not perfectly equal but as equal as possible to the extent that the request for the execution time and the allowable ranges are met. For example, in a case where two tasks having the same processing volume are requested to start execution at the same time while any other task is requested to be executed, the task scheduling portion adjusts the execution start times in such a manner that one task is executed after the execution of the other task ends.

Subsequently, the CPU operating frequency setting portion determines the operating frequency of the CPU at each time on the basis of the execution start time and the processing volume per unit time of the task determined by the task scheduling portion, and sets the operating frequency. Because the task execution portion executes the task by means of the CPU, the task can be executed to the extent that the request for the execution time of the task and the allowable range are met. Further, because the processing volume required for the CPU is made equal, it is possible to reduce the power consumption of the CPU correspondingly.

(4) As has been described, a CPU clock control device of the invention in this application is a CPU clock control device that controls a clock of its own CPU, which preferably includes: a task management portion that loads a task to be executed by the CPU and correlates the task with a request for an execution time of the task and an allowable range of the request for the execution time of the task; a task execution time registration portion that receives the request for the execution time of the task and the allowable range from the task management portion to be registered therein in correlation with the task; a task processing volume detection portion that detects a processing volume necessary to execute the task; a task execution time request interpretation portion that determines a timer event that controls the task in such a manner that the request for the execution time and the allowable range registered in the task execution time registration portion are met; a timer event registration portion that registers a request for an execution time of a timer event including the timer event determined by the task execution time request interpretation portion and an allowable range of the execution time of the timer event; a timer event processing volume detection portion that detects a processing volume necessary to execute the timer event; a timer event determining portion that determines an execution start time and a processing volume per unit time of the timer event in such a manner that a sum of the necessary processing volume detected by the task processing volume detection portion for the task executed by the timer event and the processing volume of the timer event detected by the timer event processing volume detection portion is made equal within a specific time range to the extent that the request for the execution time and the allowable range of the timer event registered in the timer event registration portion are met; a CPU operating frequency setting portion that determines an operating frequency of the CPU on the basis of the execution start time and the processing volume per unit time of the timer event determined by the timer event determining portion, and sets the operating frequency in the CPU; and a timer event execution portion that makes the CPU operating at the operating frequency set by the CPU operating frequency setting portion execute the timer event on the basis of the execution start time and the processing volume per unit time determined by the timer event determining portion.

According to this configuration, the task execution time registration portion registers the request for the execution time of the task to be executed by the CPU and the allowable range of the request for the execution time of the task under the control of the task management portion. Herein, the request for the execution time means an execution start time specifying when the task is executed, an end time specifying by what time the processing needs to end, or further an execution cycle when the task is executed periodically. Also, the allowable range means information indicating the extent of a variation allowed for the request for the execution time. For example, it indicates the extent of a gain or a delay allowed for the execution start time or the end time.

The task execution time request interpretation portion determines the timer event that controls the task in such a manner that the request for the execution time and the allowable range registered in the task execution time registration portion are met. Also, the task processing volume detection portion detects a processing volume necessary to execute the task to be executed by the CPU, and the timer event processing volume detection portion detects a processing volume necessary to execute the timer event to be executed by the CPU. The timer event registration portion then receives the processing volume necessary to execute the timer event from the timer event processing volume detection portion according to an instruction from the timer event management portion. Further, when the timer event wakes up the task, the timer event registration portion receives the processing volume necessary to execute the task from the task processing volume detection portion according to an instruction from the timer event management portion.

The timer event determining portion receives the processing volume of the timer event (and the task), the request for the execution time and the allowable range of the timer event, and the like from the timer event registration portion, and determines the execution start time and the processing volume per unit time of the timer event. In other words, the timer event determining portion makes the processing volume of the timer event alone equal when the timer event does not wake up the task, and the processing volume of the timer event plus the processing volume of the task when the timer event wakes up the task.

Subsequently, the CPU operating frequency setting portion determines the operating frequency of the CPU at each time on the basis of the execution start time and the processing volume per unit time of the timer event determined by the timer event determining portion, and sets the operating frequency. Because the timer event execution portion executes the timer event by means of the CPU, the timer event can be executed to the extent that the request for the execution time and the allowable range of the timer event are met. Further, because the processing volume required for the CPU is made equal, it is possible to reduce the power consumption of the CPU correspondingly.

(5) As has been described, a CPU clock control method of the invention in this application preferably includes: a program execution time registering step of registering a request for an execution time of a program to be executed by a CPU and an allowable range of the request for the execution time of the program in correlation with the program; a program processing volume detecting step of detecting a processing volume necessary to execute the program; a program execution time determining step of determining an execution start time and a processing volume per unit time of the program in such a manner that the processing volume detected in the program processing volume detecting step is made equal within a specific time range to the extent that the request for the execution time and the allowable range registered in the program execution time registering step are met; a CPU operating frequency setting step of determining an operating frequency of the CPU at each time on the basis of the execution start time and the processing volume per unit time of the program determined in the program execution time determining step, and setting the operating frequency in the CPU; and a program executing step of making the CPU operating at the operating frequency set in the CPU operating frequency setting step execute the program at the execution start time and the processing volume per unit time determined in the program execution time determining step.

According to this configuration, because the processing volume required for the CPU is made equal, it is possible to reduce the power consumption of the CPU correspondingly for the same reason described in the device set forth in (1).

(6) As has been described, a CPU clock control program of the invention in this application is a CPU clock control program that causes a computer to function as a CPU clock control device that controls a clock of its own CPU, and the CPU clock control program causes the computer as means as follows: program execution time registration means for registering a request for an execution time of a program to be executed by the CPU and an allowable range of the request for the execution time of the program in correlation with the program; program processing volume detection means for detecting a processing volume necessary to execute the program; program execution time determining means for determining an execution start time and a processing volume per unit time of the program in such a manner that the processing volume detected by the program processing volume detection means is made equal within a specific time range to the extent that the request for the execution time and the allowable range registered in the program execution time registration means are met; CPU operating frequency setting means for determining an operating frequency of the CPU at each time on the basis of the execution start time and the processing volume per unit time of the program determined by the program execution time determining means, and setting the operating frequency in the CPU; and program execution means for making the CPU operating at the operating frequency set by the CPU operating frequency setting means execute the program at the execution start time and the processing volume per unit time determined in the program execution time determining step.

According to this configuration, because the processing volume required for the CPU is made equal, it is possible to reduce the power consumption of the CPU correspondingly for the same reason described in the device set forth in (1).

(7) As has been described, a recording medium of the invention in this application is a computer-readable recording medium having recorded a CPU clock control program that causes a computer to function as a CPU clock control device that controls a clock of its own CPU, and the CPU clock control program causes the computer as means as follows: program execution time registration means for registering a request for an execution time of a program to be executed by the CPU and an allowable range of the request for the execution time of the program in correlation with the program; program processing volume detection means for detecting a processing volume necessary to execute the program; program execution time determining means for determining an execution start time and a processing volume per unit time of the program in such a manner that the processing volume detected by the program processing volume detection means is made equal within a specific time range to the extent that the request for the execution time and the allowable range registered in the program execution time registration means are met; CPU operating frequency setting means for determining an operating frequency of the CPU at each time on the basis of the execution start time and the processing volume per unit time of the program determined by the program execution time determining means, and setting the operating frequency in the CPU; and program execution means for making the CPU operating at the operating frequency set by the CPU operating frequency setting means execute the program at the execution start time and the processing volume per unit time determined in the program execution time determining step.

According to this configuration, because the processing volume required for the CPU is made equal, it is possible to reduce the power consumption of the CPU correspondingly for the same reason described in the device set forth in (1).

(8) As has been described, a transmission medium of the invention in this application is a transmission medium holding a CPU clock control program that causes a computer to function as a CPU clock control device that controls a clock of its own CPU, and the CPU clock control program causes the computer as means as follows: program execution time registration means for registering a request for an execution time of a program to be executed by the CPU and an allowable range of the request for the execution time of the program in correlation with the program; program processing volume detection means for detecting a processing volume necessary to execute the program; program execution time determining means for determining an execution start time and a processing volume per unit time of the program in such a manner that the processing volume detected by the program processing volume detection means is made equal within a specific time range to the extent that the request for the execution time and the allowable range registered in the program execution time registration means are met; CPU operating frequency setting means for determining an operating frequency of the CPU at each time on the basis of the execution start time and the processing volume per unit time of the program determined by the program execution time determining means, and setting the operating frequency in the CPU; and program execution means for making the CPU operating at the operating frequency set by the CPU operating frequency setting means execute the program at the execution start time and the processing volume per unit time determined in the program execution time determining step.

According to this configuration, because the processing volume required for the CPU is made equal, it is possible to reduce the power consumption of the CPU correspondingly for the same reason described in the device set forth in (1).

While the invention has been described in detail, the descriptions above are only illustrative in all aspects, and the invention is not therefore limited to the descriptions. It is understood that a number of modifications that are not described herein can be anticipated without deviating from the scope of the invention.

### INDUSTRIAL APPLICABILITY

The CPU clock control device and method of the invention are effective in diversified fields as long as an information processing apparatus is used. For example, they are applicable in the form of not only a large-scale computer system and a personal computer, but also various home appliances, communication devices, such as a cellular phone, industrial equipment, and passenger equipment.

1-8. (canceled)

9. A CPU clock control device that controls a clock of its own CPU, comprising:
a program management portion that loads a program to be executed by the CPU and correlates the program with a request for an execution time and an allowable range of the request for the execution time of the program;
a program execution time registration portion that receives the request for the execution time and the allowable range from the program management portion to be registered therein in correlation with the program;
a program processing volume detection portion that detects a processing volume necessary to execute the program;
a program execution time determining portion that determines an execution start time and a processing volume per unit time of the program in such a manner that the processing volume detected by the program processing volume detection portion is made equal within a specific time range to the extent that the request for the execution time and the allowable range registered in the program execution time registration portion are met;
a CPU operating frequency setting portion that determines an operating frequency of the CPU at each time on the basis of the execution start time and the processing volume per unit time of the program determined by the program execution time determining portion, and sets the operating frequency in the CPU; and
a program execution portion that makes the CPU operating at the operating frequency set by the CPU operating frequency setting portion execute the program at the execution start time and the processing volume per unit time determined by the program execution time determining portion.

10. The CPU clock control device according to claim 9, further comprising:
an interrupt processing portion that performs an interrupt processing performed at an occurrence of an interrupt;
an interrupt processing volume detection portion that detects a processing volume necessary for the interrupt processing; and
an interrupted execution time adjustment portion that determines again the execution start time and the processing volume per unit time of the program when the interrupt processing portion performs the interrupt processing at an occurrence time of the interrupt in such a manner that the processing volume necessary to execute the program and the processing volume of the interrupt processing are made equal within a specific time range to the extent that the request for the execution time and the allowable range registered in the program execution time registration portion are met, wherein:
the CPU operating frequency setting portion determines the operating frequency of the CPU on the basis of a new processing volume, which is one of the processing volume made equal by the program execution time determining portion and the processing volume made equal by the interrupted execution time adjustment portion; and
the program execution portion executes the program at new execution start time and processing volume per unit time, which is one of the execution start time and the processing volume per unit time determined by the program execution time determining portion and the execution start time and the processing volume per unit time determined again by the interrupted execution time adjustment portion.

11. A CPU clock control device that controls a clock of its own CPU, comprising:
a task management portion that loads a task to be executed by the CPU and correlates the task with a request for an execution time of the task and an allowable range of the request for the execution time of the task;
a task execution time registration portion that receives the request for the execution time and the allowable range from the task management portion to be registered therein in correlation with the task;
a task processing volume detection portion that detects a processing volume necessary to execute the task;
a task scheduling portion that sets a schedule of an execution start time and a processing volume per unit time of the task in such a manner that the processing volume detected by the task processing detection portion is made equal within a specific time range to the extent that the request for the execution time and the allowable range registered in the task execution time registration portion are met;
a CPU operating frequency setting portion that determines an operating frequency of the CPU on the basis of the execution start time and the processing volume per unit time of the task scheduled by the task scheduling portion, and sets the operating frequency in the CPU; and
a task execution portion that makes the CPU operating at the operating frequency set by the CPU operating frequency setting portion execute the task according to the schedule set by the task scheduling portion.

12. A CPU clock control device that controls a clock of its own CPU, comprising:
a task management portion that loads a task to be executed by the CPU and correlates the task with a request for an execution time of the task and an allowable range of the request for the execution time of the task;
a task execution time registration portion that receives the request for the execution time and the allowable range from the task management portion to be registered therein in correlation with the task;
a task processing volume detection portion that detects a processing volume necessary to execute the task;
a task execution time request interpretation portion that determines a timer event that controls the task in such a manner that the request for the execution time and the allowable range registered in the task execution time registration portion are met;
a timer event registration portion that registers a request for an execution time of a timer event including the timer event determined by the task execution time request interpretation portion and an allowable range of the execution time of the timer event;
a timer event processing volume detection portion that detects a processing volume necessary to execute the timer event;
a timer event determining portion that determines an execution start time and a processing volume per unit time of the timer event in such a manner that a sum of the necessary processing volume detected by the task processing volume detection portion for the task executed by the timer event and the processing volume of the timer event detected by the timer event processing volume detection portion is made equal within a specific time range to the extent that the request for the execution time and the allowable range of the timer event registered in the timer event registration portion are met;
a CPU operating frequency setting portion that determines an operating frequency of the CPU on the basis of the execution start time and the processing volume per unit time of the timer event determined by the timer event determining portion, and sets the operating frequency in the CPU; and
a timer event execution portion that makes the CPU operating at the operating frequency set by the CPU operating frequency setting portion execute the timer event on the basis of the execution start time and the processing volume per unit time determined by the timer event determining portion.

13. A CPU clock control method, including:
a program execution time registering step of registering a request for an execution time of a program to be executed by a CPU and an allowable range of the request for the execution time of the program in correlation with the program;
a program processing volume detecting step of detecting a processing volume necessary to execute the program;
a program execution time determining step of determining an execution start time and a processing volume per unit time of the program in such a manner that the processing volume detected in the program processing volume detecting step is made equal within a specific time range to the extent that the request for the execution time and the allowable range registered in the program execution time registering step are met;
a CPU operating frequency setting step of determining an operating frequency of the CPU at each time on the basis of the execution start time and the processing volume per unit time of the program determined in the program execution time determining step, and setting the operating frequency in the CPU; and
a program executing step of making the CPU operating at the operating frequency set in the CPU operating frequency setting step execute the program at the execution start time and the processing volume per unit time determined in the program execution time determining step.

14. A computer-readable recording medium having recorded a CPU clock control program that causes a computer to function as a CPU clock control device that controls a clock of its own CPU, the CPU clock control program causing the computer as means as follows:
program execution time registration means for registering a request for an execution time of a program to be executed by the CPU and an allowable range of the request for the execution time of the program in correlation with the program;
program processing volume detection means for detecting a processing volume necessary to execute the program;
program execution time determining means for determining an execution start time and a processing volume per unit time of the program in such a manner that the processing volume detected by the program processing volume detection means is made equal within a specific time range to the extent that the request for the execution time and the allowable range registered in the program execution time registration means are met;
CPU operating frequency setting means for determining an operating frequency of the CPU at each time on the basis of the execution start time and the processing volume per unit time of the program determined by the program execution time determining means, and setting the operating frequency in the CPU; and
program execution means for making the CPU operating at the operating frequency set by the CPU operating frequency setting means execute the program at the execution start time and the processing volume per unit time determined in the program execution time determining means.

15. A transmission medium holding a CPU clock control program that causes a computer to function as a CPU clock control device that controls a clock of its own CPU, the CPU clock control program causing the computer as means as follows:
program execution time registration means for registering a request for an execution time of a program to be executed by the CPU and an allowable range of the request for the execution time of the program in correlation with the program;
program processing volume detection means for detecting a processing volume necessary to execute the program;
program execution time determining means for determining an execution start time and a processing volume per unit time of the program in such a manner that the processing volume detected by the program processing volume detection means is made equal within a specific time range to the extent that the request for the execution time and the allowable range registered in the program execution time registration means are met;
CPU operating frequency setting means for determining an operating frequency of the CPU at each time on the basis of the execution start time and the processing volume per unit time of the program determined by the program execution time determining means, and setting the operating frequency in the CPU; and
program execution means for making the CPU operating at the operating frequency set by the CPU operating frequency setting means execute the program at the execution start time and the processing volume per unit time determined in the program execution time determining means.
